(19) United States
(12) Patent Application Publication
(10) Pub. No.: US 2022/0179543 A1
(43) Pub. Date: Jun. 9, 2022

(54) USER INTERFACE SYSTEM, METHOD AND DEVICE

(71) Applicant: Sandeep Kumar Rayapati, Eluru (IN)

(72) Inventor: Sandeep Kumar Rayapati, Eluru (IN)

(21) Appl. No.: 17/440,763

(22) PCT Filed: Mar. 23, 2020
(86) PCT No.: PCT/IB2020/052674

§ 371 Date: Sep. 18, 2021

(30) Foreign Application Priority Data
Mar. 24, 2019 (IN) 201941011376

(51) Int. Cl. G06F 3/04842

(52) U.S. Cl. CPC G06F 3/04842; G06F 3/04883

(57) ABSTRACT

Exemplary embodiments of the present disclosure are directed towards a user interface (UI) system comprising a user command input assembly, a processor and a focus zone defined within a display of a computing device. When one or more selectable display items are within the focus zone, receiving a selection command via the user command input assembly, results in, as enabled by the processor, the selection of a selectable item.

### TECHNICAL FIELD

The present invention relates to a novel system and method for interfacing with computing devices such as smartphones, tablets, and the like. The invention also relates to a computing device that is incorporated with novel user interface elements.

### BACKGROUND

As can be appreciated from FIG. 1, user controls such as, the volume 12, lock 14, fingerprint scanner, home 16, back 18, recent apps 20 keys, on a smartphone 10 (or a phablet) are positioned apart from one another at different locations viz., on the sides, front and the rear of the smartphone 10. Therefore, when the smartphone 10 is being operated single-handedly by a user, the placement of said controls, in addition to accessing the touchscreen beyond the area of reach of the thumb, causes the user to move his/her thumb all over the smartphone while constantly changing the grip of his/her hand with respect to the smartphone 10. This makes the smartphone-wield unstable making it prone to slippages that may result in smartphone 10 damage.

### SUMMARY

An embodiment of the present disclosure is directed to a User Interface (UI) system for single-handed navigation of a handheld computing device, which comprises a smartphone or other such devices that have a form factor similar to that of a smartphone. The system comprises a thumbpiece comprising planar touch-gesture input surface disposed on a side edge of the smartphone so as to be accessible by the thumb of the user. The touch surface is disposed in operative communication with the smartphone display such that, when the smartphone is displaying scrollable content thereon, swiping on the thumbpiece along the longitudinal (vertical) axis thereof causes the scrollable content to be scrolled accordingly.

Further, when the smartphone is unlocked, swiping on the thumbpiece along the lateral (horizontal) axis in a first direction causes the smartphone to invoke the function that is the resultant of the conventional actuation of the conventional “recent apps” key thereby displaying recent apps. Further, when the smartphone is displaying any screen other than the home-screen thereof, swiping on the thumbpiece along the lateral axis in an opposing second direction causes the smartphone to invoke the function that is the resultant of the actuation of the conventional “back” key thereby displaying screen that is last accessed by the user. In an additional embodiment, the thumbpiece further comprises a fingerprint reader integrated thereinto for, inter alia, locking and unlocking the smartphone biometrically.

In one embodiment, the touch surface is programmed to read additional touch gestures such as, for example, double-tapping thereon. Said double-tapping may result in the invocation of the conventional “home” key on a smartphone leading to the home-screen. In another example, said double-tapping may result in locking the smartphone. The thumbpiece further comprises three physical keys viz., a pair of volume up and down keys and a home (or lock) key, wherein the touch surface is disposed atop the three physical keys. Preferably, the home key is disposed between the volume keys.

The system further comprises a focus zone, which comprises a rectangular area of smartphone display extending between the longitudinal edges of the screen. The focus zone is preferably disposed within the top half of the smartphone screen wherein, said location is where the user's eyes naturally land when looking at the smartphone display in portrait mode. The system is configured such that, when a selectable item (such as, a link to another screen, an app, a text-input section, etc.) or a part thereof, is within (or brought to be within) the purview of the focus zone, tapping on the thumbpiece leads to the selection of said “focused” item.

Other features and advantages will become apparent from the following description of the preferred embodiments, taken in conjunction with the accompanying drawings.

### BRIEF DESCRIPTION OF FIGURES

FIG. 1 is an illustration of a smartphone known in the art.

FIG. 2 is an illustration of the smartphone depicting the comport zone of the thumb on the display as the held single-handedly.

FIG. 3 is an illustration of a smartphone being “standard-gripped.”

FIG. 4 is an illustration of a perspective view of the smartphone.

FIG. 5 is an illustration of the plan view of the thumbpiece.

FIG. 6 is an illustration of a side view of the smartphone.

FIG. 7 is an illustration depicting the content of the smartphone being scrolled via the thumbpiece.

FIG. 8 is an illustration depicting the focus zone defined within the display screen.

FIG. 9 depicts sequential illustrations involved in the selection of a YouTube video link (YouTube®) via the thumbpiece.

FIG. 10 is an illustration of focus zone encompassing, inter alia, a default item 64 within a preselection frame.

FIG. 11 depicts sequential illustrations involved in “extra-locking” a default item 64.

FIG. 12 depicts, according to an embodiment of the present invention, the positioning of the additional options closer to a side edge of the smartphone display.

FIG. 13 is an illustration depicting the invocation of the “recent apps” function as the thumbpiece is swiped thereupon laterally.

FIG. 14 is an illustration depicting the thumbpiece being swiped laterally thereupon so as to invoke the “back” function.

FIG. 15 is, according to an embodiment of the present invention, an illustration of the thumbpiece comprising two keys.

FIG. 16 is, according to an embodiment of the present invention, an illustration of the plan view of the joy-piece.

FIG. 17 is, according to an embodiment of the present invention, an illustration of the plan view of the pointing-piece.

FIG. 18 is, according to an embodiment of the present invention, an illustration of the plan view of the scroll-piece.

FIG. 19 is, according to an embodiment of the present invention, an illustration of the plan view of the track-piece.

FIG. 20 is an illustration of a perspective view of the smartphone showing the map key.

FIG. 21 is an illustration depicting the launch of app drawer via the thumbpiece and the map key.

FIG. 22 is an illustration depicting the launch of notification panel via the thumbpiece and the map key.

FIGS. 23A through 23C comprise sequential illustrations involved in the selection of default app, control and link respectively.

FIG. 24 is an illustration depicting the conversion of focused apps to locked apps.

FIGS. 25A and 25B depict the blurring effect on Twitter (Twitter®) and the app drawer respectively.

FIGS. 26A and 26B are sequential illustrations depicting the sequential preselection process.

FIG. 27 is an exemplary screenshot of a settings screen with the links therein looped.

FIG. 28 illustrates the shifting of the focus zone.

FIG. 29 is an exemplary screenshot of the YouTube app (YouTube®) with top and bottom sections.

FIG. 30 is an exemplary screenshot of the Twitter app (Twitter®) with hamburger menu laid atop the main feed screen.

FIGS. 31A and 31B depict the clusters in exemplary Twitter® and YouTube feeds (YouTube®).

FIGS. 32A and 32B are exemplary clusters pertaining to Twitter® and YouTube®).

FIG. 33 depict sequential illustrations involved in the selection of a focused cluster.

FIG. 34 is, according to an embodiment of the present invention, an exemplary screenshot of an extra-locked Twitter® cluster.

FIG. 35 depicts, according to an embodiment of the present invention, exemplary sequential illustrations involved in “liking” a selectable item.

FIG. 36 is, according to an embodiment of the present invention, an illustration of a tablet PC comprising the thumbpiece and the map key.

FIG. 37 is an illustration of a perspective view of the smartphone case.

FIG. 38 is an illustration of another perspective view of the smartphone case.

FIG. 39 is an illustration of the plan view of the smart control pieces.

FIG. 40 is an illustration of a smartphone attached with the smart control pieces.

FIG. 41 is a flowchart mapping the process involved in selecting a default item 64 via the UI method.

FIG. 42 is a flowchart mapping the process involved in selecting a non-default item 64 via the UI method.

FIG. 43 is a block diagram of an exemplary computer-implemented system.

FIG. 44 is an exemplary number pad keyboard employed by the system.

FIG. 45 is an exemplary game controller comprising the thumbpiece and the map key.

FIG. 46 is an exemplary TV controller comprising the thumbpiece and the map key.

FIG. 47 is a block diagram of the UI system of the present invention.

FIG. 48 is an illustration depicting a cluster sandwiched between a pair of top and bottom cluster boundaries.

FIG. 49 is an illustration of smartphone case for a left-handed user; the smartphone case housing the smartphone.

FIG. 50 is another illustration of smartphone case for a left-handed user; the smartphone case housing the smartphone.

### DETAILED DESCRIPTION

Embodiments of the present disclosure are explained in detail below with reference to the various figures. In the following description, numerous specific details are set forth to provide an understanding of the embodiments and examples. However, those of ordinary skill in the art will recognize a number of equivalent variations of the various features provided in the description. Furthermore, the embodiments and examples may be used together in various combinations.

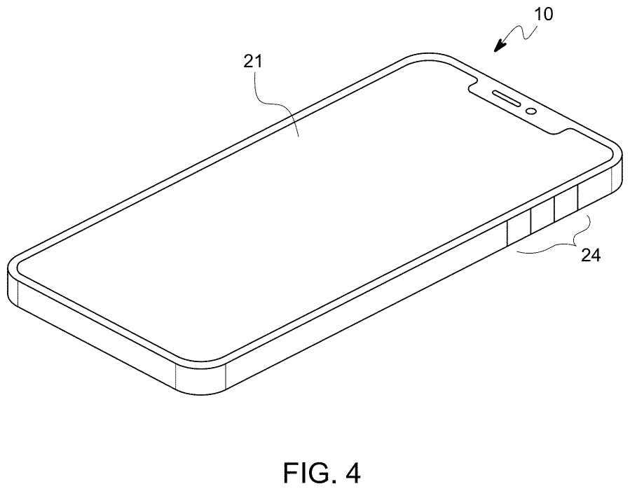

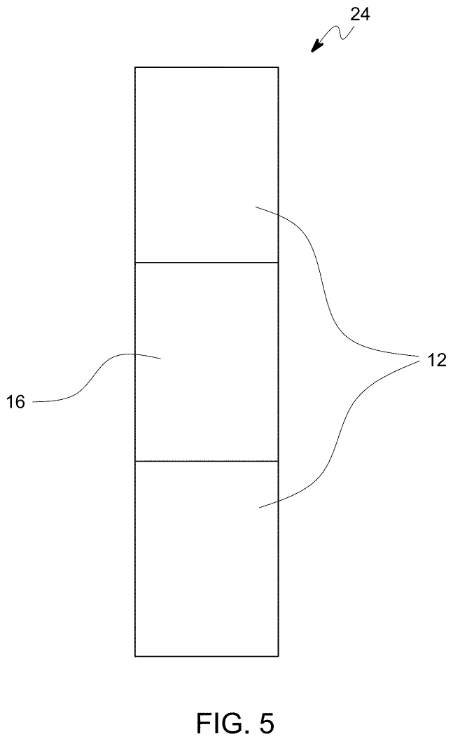

The following specification discloses embodiments of the present invention that are directed to a User Interface (UI) system & method for accessing a computing. The specification also discloses embodiments that are directed to the device itself (i.e., for instance, the smartphone 10 shown in FIGS. 4 to 9, 11, 13 to 24, 26, 28, 33, 35 & 36) that is incorporated with the novel UI elements. The specification also further discloses embodiments directed to a device case paired to the computing device wherein, the case is incorporated with the UI elements. The specification also further yet discloses an external controller paired to a larger computing device such as a smart TV.

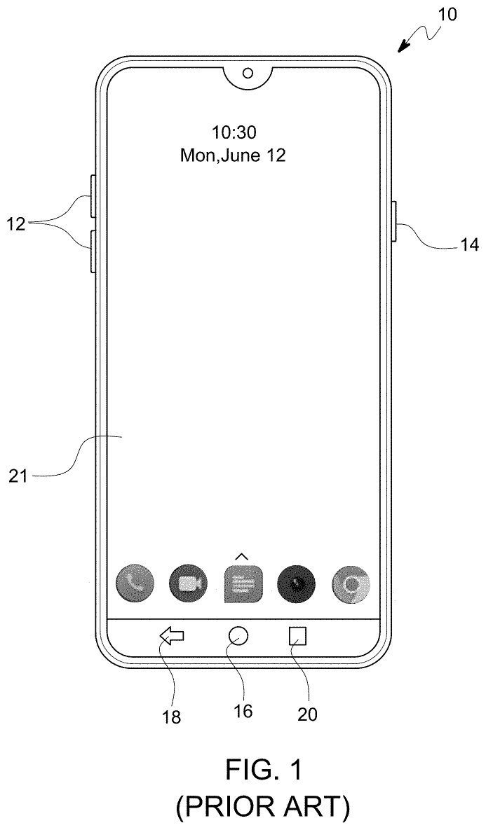

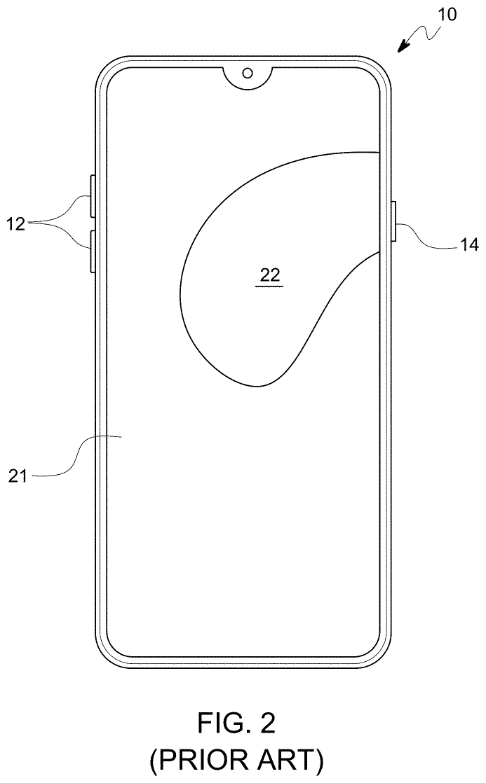

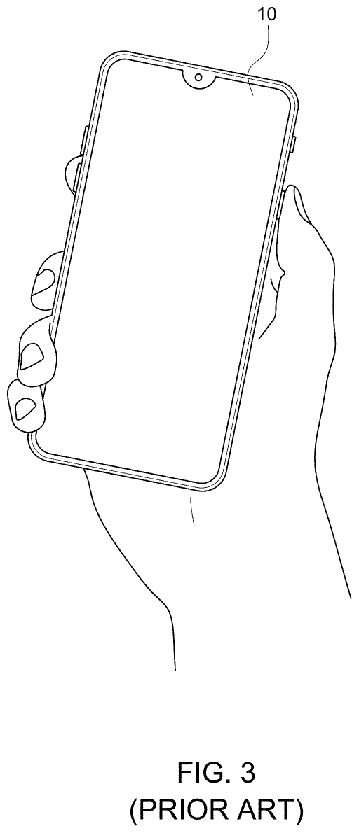

The computing device comprises a smartphone 10, however, said system and method may also be adapted for other devices such as, tablets, phablets, laptops, smart TVs, external controllers, etc. Referring to FIG. 1, the frequently used keys, including both physical and virtual keys, on a smartphone 10 viz., the volume up and down keys 12, the lock/unlock key 14, the home key 16, the back key 18, the recent apps key 20 and the fingerprint scanner, are placed apart from one another and at different locations. As a result of this, the user, in order to operate said keys when the smartphone 10 is being single-handedly gripped, needs to change his/her grip constantly with respect to the smartphone 10. The same thing also holds true for accessing the touchscreen display 21 beyond the comfort zone 22 of the thumb as the smartphone 10 is single-handedly gripped as seen in FIG. 2. Notably, as can be appreciated from FIG. 3, single-handedly gripping the smartphone 10 such that, the user's hand wraps around the rear of the smartphone 10 while at least three fingers and the thumb rest on the opposing longitudinal edges of the smartphone 10 is referred to as “standard-gripping” hereinafter. Single-handedly constantly changing one's grip makes the smartphone-wield unstable making it prone to falls and slippages. The system of the present invention is aimed at delivering a better smartphone 10 interface experience to the user, especially when the smartphone 10 is standard-gripped.

The UI system (hereinafter, “the system”) comprises a user command input assembly for receiving user commands whereafter, said user commands are relayed to a processor, which in turn performs smartphone functions corresponding to said user commands. More particularly, the system comprises a function database where, each user command is pre-associated with a smartphone function. The function database is sometimes part of the operating system, sometimes part of the app installed on the smartphone 10, and sometimes part of both. Once a user command is received by the processor, via the user command input assembly, the function database is parsed for a match. Upon match, the corresponding smartphone function is duly executed. Notably, a user command could be generic, i.e., resulting in the same smartphone function throughout all smartphone apps and screens, or contextual, i.e., resulting in different smartphone functions for different smartphone apps and screens (for the execution of the same user command).

Referring to FIGS. 4 through 6, the user command input assembly comprises a thumbpiece 24, which in turn comprises a planar touch-gesture input surface (hereinafter, the “touch surface”). The touch surface is overlaid atop three adjacently-abutting keys viz., a pair of volume control keys 12 and a middle key. The thumbpiece 24 is integrated into a side edge of the smartphone 10 so as to be accessible by the thumb of the user as the smartphone 10 is standard-gripped. Preferably, the touch surface is flush with the side edge of the smartphone 10. In one embodiment, the touch surface is integrated with a fingerprint scanner.

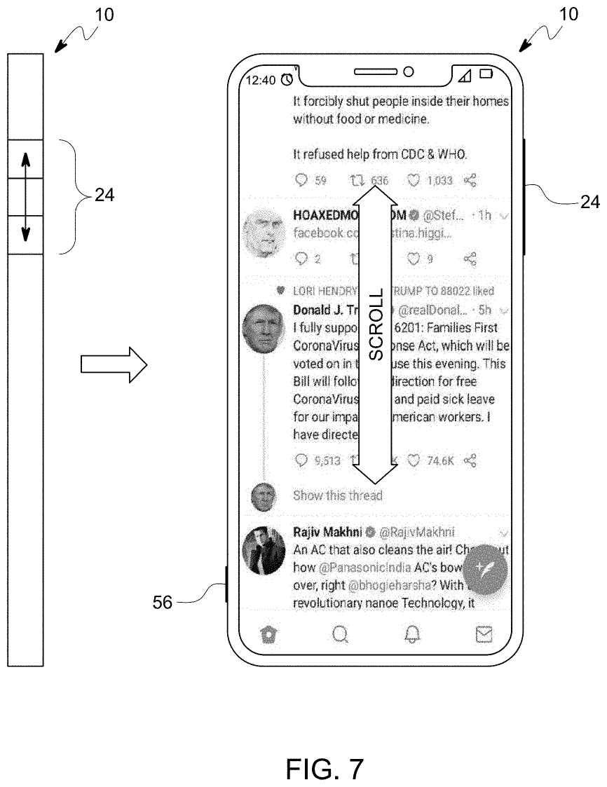

The touch surface is disposed in operative communication with the smartphone display 21 such that, when the smartphone 10 is displaying scrollable content thereon, swiping on the touch surface along the longitudinal (vertical) axis thereof causes the scrollable content to be scrolled accordingly as seen in FIG. 7. In an alternate embodiment, the system is configured such that, swiping down on the thumbpiece 24 causes the scrollable content to be scrolled upwards and vice versa. Notably, the scrollable content may be vertically or horizontally scrollable. The longitudinal scrolling on the thumbpiece 24 is referred to as inputting a scroll command, which comprises a scroll gesture. In one embodiment, the system is configured such that, when the user swipes up on the touch surface and holds at the top extremity thereof, the display jumps to the top of the scrollable content thereby mimicking the “home” or “refresh” key on several feed-based apps like Twitter, Instagram®, YouTube, (Twitter®, Instagram®, YouTube®) etc. Similarly, swiping down on the touch surface and holding at the bottom extremity thereof causes the display to jump to the bottom of the scrollable content. The touch-gestures of longitudinally scrolling a holding at the top and bottom extremities of the thumbpiece 24 are referred to as top and bottom commands respectively, which may also be referred to as top and bottom touch-gestures respectively. Alternatively, instead of swiping and holding, double tapping on the top and bottom extremities of the touch surface results in the scrollable content being jumped all the way to the top and bottom thereof respectively. When the smartphone display 21 is displaying scrollable content, which is currently not the top-most of the scrollable content, the reception of a top command via the user command input assembly results in the display of the top-most of the scrollable content. The top command is akin to the home button on Twitter™, Instagram™, etc., wherein selecting said home button results in the content feed jumping to the top. The top command, which is a user command, comprises a top gesture comprising swiping up longitudinally on the touch surface and holding at its extremity. Alternatively, the top command may be delivered via at least one type of user input being a key input, a joystick input, a pointing-piece input, a scroll wheel input or a trackball input. Similarly, when the display is displaying scrollable content, which is currently not the bottom-most of the scrollable content, the reception of a bottom command via the user command input assembly results in the display of the bottom-most of the scrollable content. The bottom command comprises a bottom gesture comprising swiping down on the touch input surface and holding at its extremity.

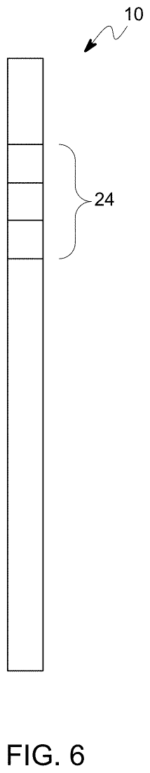

Referring to FIGS. 4 and 6, preferably, the thumbpiece 24 is located on the right-side edge of the smartphone 10 so as to be accessible by the right thumb of the user. Alternatively, the thumbpiece 24 may be located on the left side edge of the smartphone 10 so as to be accessible by the left thumb of the user. In one embodiment, a thumbpiece 24 may be located on both the right and left side edges of the smartphone 10 so as to be accessible by the right and left thumbs of the user. In one embodiment, the thumbpiece 24 and the side edge, whereon the thumbpiece 24 is located, are configured to be monolithically integrated whereby, the side edge (whereon the thumbpiece 24 is located) appears unitary. The thumbpiece 24 is wide (or thick) enough to register a lateral (or horizontal) swipe, the utility of which will be disclosed in the following body of text.

In an alternate embodiment (not shown), the thumbpiece 24 is located on the back of the smartphone 10 so as to be accessible by the index finger of the user. In one embodiment, two thumbpieces 24 may be employed wherein, one is employed on the side (so as to be accessible by the thumb), while the other is employed on the back of the smartphone 10 (so as to be accessible by the index finger). In alternate embodiments, the system is configured such that, swiping along the longitudinal axis of the thumbpiece 24 may result in other smartphone functions such as, adjusting the volume, screen brightness, locking and unlocking the smartphone 10, camera zooming and un-zooming, receiving and rejecting phone calls, etc. In an alternate embodiment, the functions resulting from swiping on the thumbpiece 24 along the longitudinal axis are user-configurable.

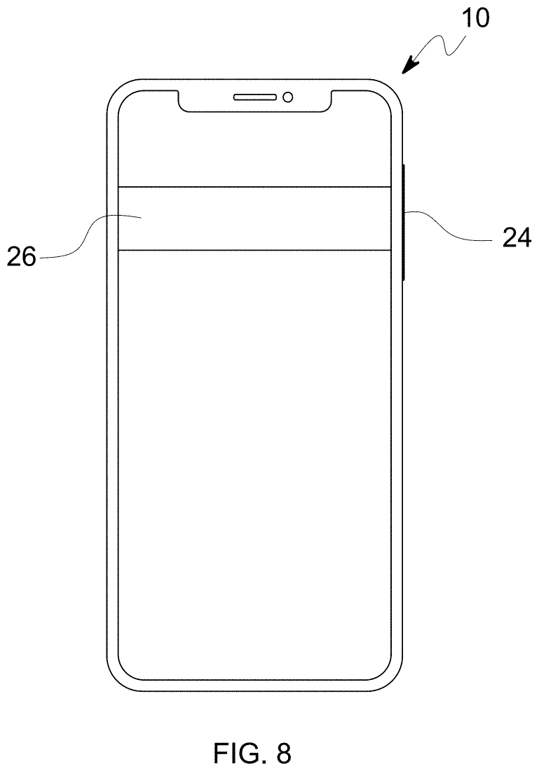

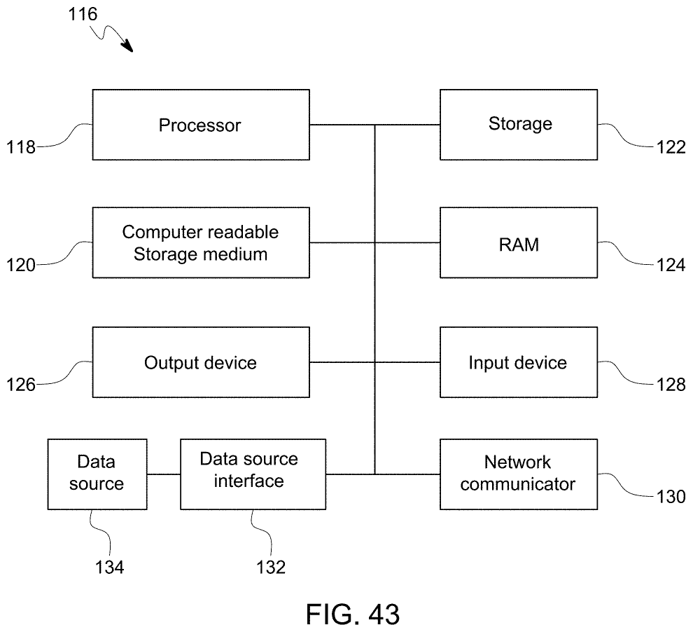

Referring to FIG. 8, the system comprises a focus zone 26 defined within the display 21 of the smartphone 10 More particularly, the focus zone 26 comprises a horizontal strip of an area (or rectangular area) extending between the longitudinal edges of the display screen 21. More particularly, the vertical boundaries of the focus zone 26 comprises the vertical (longitudinal) boundaries of the screen (or the smartphone display) displaying content thereon such as, the app screen as the smartphone 10 is held in portrait orientation. The focus zone 26 is preferably located within the top half of the smartphone screen as said smartphone screen is in portrait orientation. Notably, the focus zone 26 is the portion of the smartphone display 21 where the user's eyes naturally land when one looks at the smartphone display 21 in portrait orientation. In one embodiment, the position of the focus zone 26 is configured to be user-adjustable. Notably, the processor (shown in FIG. 43) is configured to adapt and display content in portrait orientation of the smartphone (tablet, phablet, etc.).

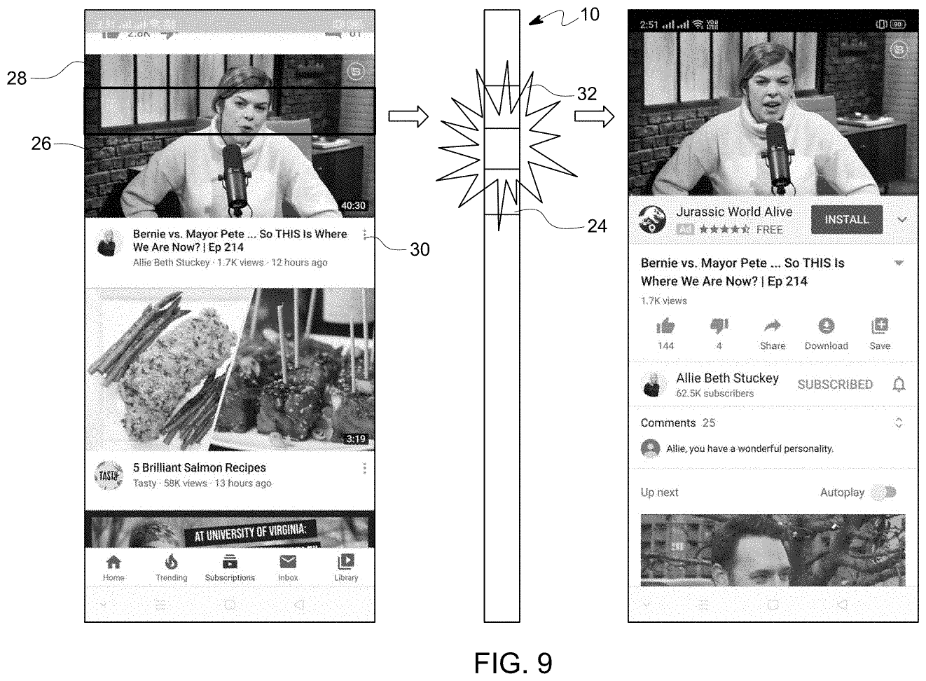

Referring to FIG. 8, the system is configured such that, when a user-selectable display item (such as, a hyperlink (or link) to another screen, an app icon (or simply an “app”), a text-input section, a key of a virtual keyboard, etc.) or a part thereof, is within (or brought to be within) the purview of the focus zone 26, whereby said selectable item is said to “focused”, receiving a selection gesture (which is a selection command) via the thumbpiece 24 leads to said “focused” selectable item being selected. Said selection of the focused item 62, as enabled by the processor, includes said item being actuated, launched, toggled/de-toggled, activated/deactivated, deployed, etc. Notably, when a selectable item is within the focus zone 26, said selectable item is referred to as the “focused” item. In the event of there being only one focused item 62, said focused item 62 is preselected by default. On the other hand, in the event of there being multiple focused items 62, only one item thereof is preselected by default. The item that is preselected by default is referred to as the “default” item The selection gesture (or command) comprises single-tapping 32 on the thumbpiece 24. Alternatively, the selection gesture may comprise one of a myriad of touch-gesture expressions such as, double-tapping, long-tapping 38 (i.e., tapping and holding on the thumbpiece 24), etc. Notably, long-tapping 38 comprises placing, holding and releasing one's thumb or finger from the thumbpiece 24. An exemplary FIG. 9 depicts a YouTube (YouTube®) video link 28 (or a part thereof) being within the purview of the focus zone 26. At this point, single-tapping 32 on the thumbpiece 24 leads to the corresponding video link 28 being selected for play as seen in the second exemplary screenshot.

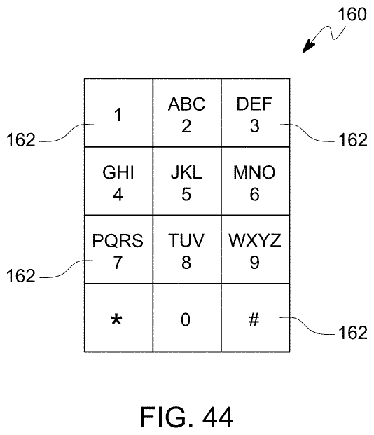

In the event where there exist multiple focused items 62 (i.e., the multiple selectable items that are within the focus zone 26), the system is, as enabled by the processor, configured to predetermine a focused item 62 that is most spatially dominant to be the default item 64. Alternatively, the default item 64 may be the one that is centrally-disposed. In another embodiment, the default item 64 may be user-configurable. In yet another embodiment, the default item 64 may be preconfigured. Revisiting the earlier example, if the video link 28 and the pop-up menu link 30 fall within the focus zone 26, then single-tapping 32 on the thumbpiece 24 results in the selection of the video link 28 (which is spatially-dominant compared to the pop-up link 28). In an alternate embodiment, in the event where there are multiple focused items 62, the system predetermines the default item 64 to be the one that is more frequently selected. For example (not shown), between “reply”, “retweet” and “like” focused keys (or links) of the Twitter app (Twitter®), the system, upon single-tapping 32 on the thumbpiece 24, is configured to select the ‘like’ key, which exemplarily is the most used of the three focused item 62. If a text-input section is focused and eventually selected (by single-tapping 32 on the thumbpiece 24), the system is configured to launch a keyboard, via which text is entered into the text-input section. In one embodiment, the keyboard includes a voice-input command built thereinto, wherein selecting the voice-input command results in the text being inputted into the text-input section through user voice. In one embodiment, the keyboard includes a T9 keyboard as seen in FIG. 44.

In an alternate embodiment, in the event where there are multiple focused item 62, the system predetermines a focused item 62 to be a default item 64 based on the position thereof within the focus zone 26. For example, the default item 64 may be first, middle or the last focused item 62 within the focus zone 26. In an additional embodiment, the system predetermines a focused item 62 to be a default item 64 upon said default item 64 being spatially-dominant, centrally-disposed, or both. In one embodiment, the basis for the system in predetermining a default item 64 is contextual, i.e., varies from app to app and page to page that is being displayed.

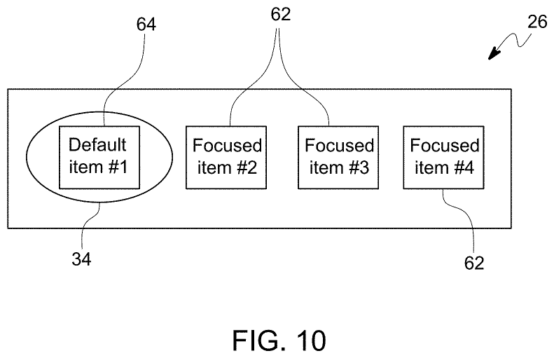

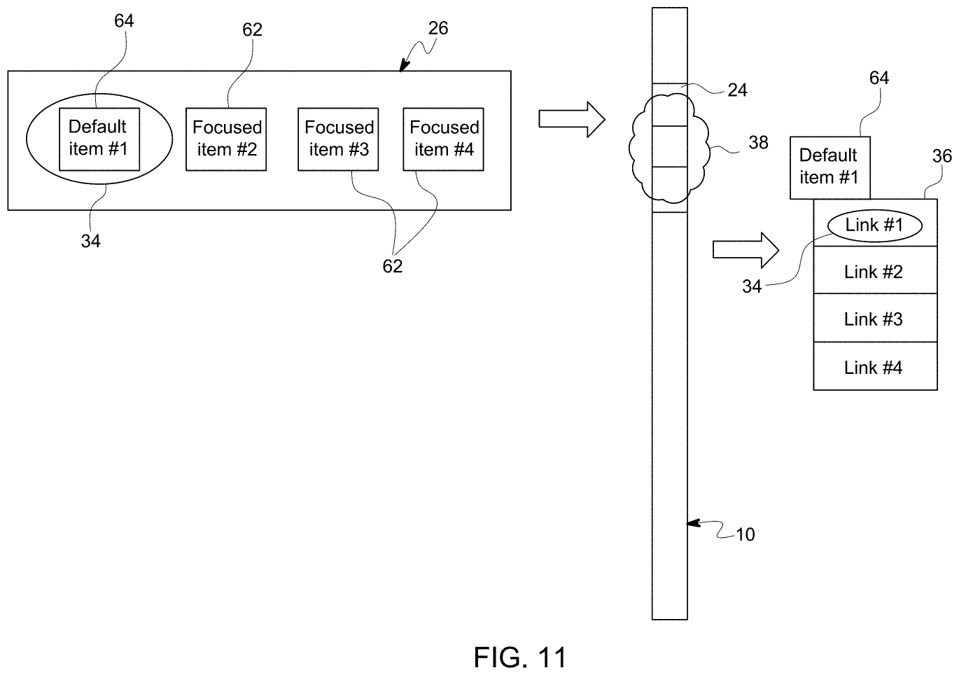

In one embodiment, in the event of there being more than one focused item 62, the system is configured to visually indicate a default item 64 so as to enable the user to be aware of which item is preselected. Said visual indication may comprises a visual “pop” of the preselected item, a frame around the preselected item, or the like. For example, in FIG. 10, a preselection frame 34 is employed to visually express the default item 64 bearing the number “1.” In an additional embodiment, upon receiving an “extra-lock” command via the thumbpiece 24, the system causes the display of additional options (i.e., additional selectable links) pertaining to the default item 64 (or any preselected item) preferably in a pop-up menu style (36, FIG. 11), etc. The extra-lock command comprises an extra-lock gesture comprising long-tapping (38, FIG. 11), which comprises placing one's thumb on the thumbpiece 24 and holding it for a short amount of time before releasing it. However, other touch-gestures, double-tapping, swiping, etc., may be employed instead of long-tapping 38. Notably, one of the options comprises a “default” option whereby, single-tapping 32 at this point on the thumbpiece 24 results in the default option being selected. Notably, the default additional option may also be extra-locked to result in further additional options pertaining to the default additional option to be displayed in a similar manner. At this point, the user is, by further performing longitudinal (vertical) swiping on the thumbpiece 24, enabled to preselect the additional options one option at a time. Said longitudinal swiping could be one longitudinal swipe per option thereby entailing the user to perform multiple longitudinal swipes to reach multiple options. Notably, the longitudinal swipes are looped whereby, the last option could be accessed first by swiping in the reverse direction (i.e., an upward swipe).

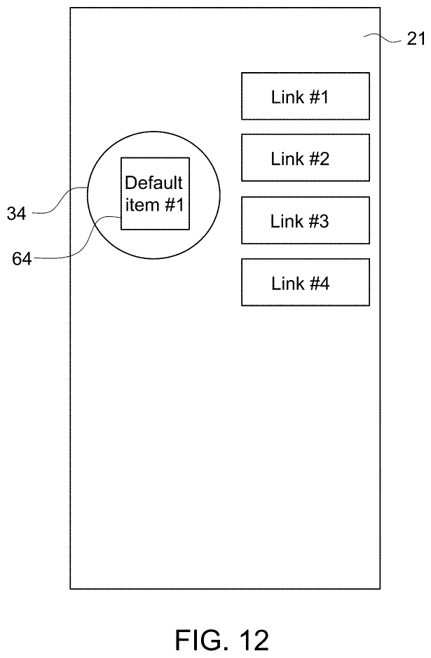

Alternatively, said longitudinal swiping could be performing one single longitudinal swipe to preselect all options, one at a time. This is done by breaking up the single longitudinal swipe into a plurality of swipe segments wherein, each swipe segment preselects one option. For example, let's say there are five options that pop-up from the long-tapped 38 preselected item. As the first option is already preselected by default, performing one-fourth of the swipe (i.e., the first swipe segment) results in the second option being preselected, performing half swipe results in the middle option being preselected, performing three-fourths of the swipe results in the third option being preselected and finally, performing the full swipe results in the last option being preselected. In an additional embodiment, said single swipe is looped whereby, the last option could be reached first by swiping in the opposite direction. In one embodiment, the focus zone 26 is configured to be invisible whereby when selectable items are within the focus zone 26, they are visually made known to be within the focus zone 26 via an exemplary “pop”, a frame around them, or the like. In one embodiment, instead of employing the pop-up menu 36 (FIG. 11) style, the additional options (viz., Links #1 to 4 pertaining to the focused item 62 #1 of FIG. 11) are displayed closer to the side edge of the display 21 (ref. FIG. 12) so as to be accessible by the thumb of the user, who is standard-gripping the smartphone 10. In an additional embodiment, the Links #1 to 4 are pre-selectable via longitudinal swiping on the thumbpiece 24.

In one embodiment, as the vertically scrollable content is scrolled downward by swiping downward on the thumbpiece 24, the position of the focus zone 26 is configured to be shifted be slightly downwards so as to afford time to the user in making a selection decision. In one embodiment, the focus zone 26 is configured to be user enabled and disabled.

In one embodiment (not shown), the focus zone 26 is divided into a plurality of segments wherein, each of the plurality of segments is treated as the focus zone 26 itself. The system is configured such that, each focus zone segment, comprising one or more selectable items, is adapted to be focused one at a time. Each focus zone segment is sequentially focused via longitudinal swiping or the like. When a focus zone segment is focused with one or more selectable items, inputting the selection command at that point results in the selection of a default item within the focus zone segment.

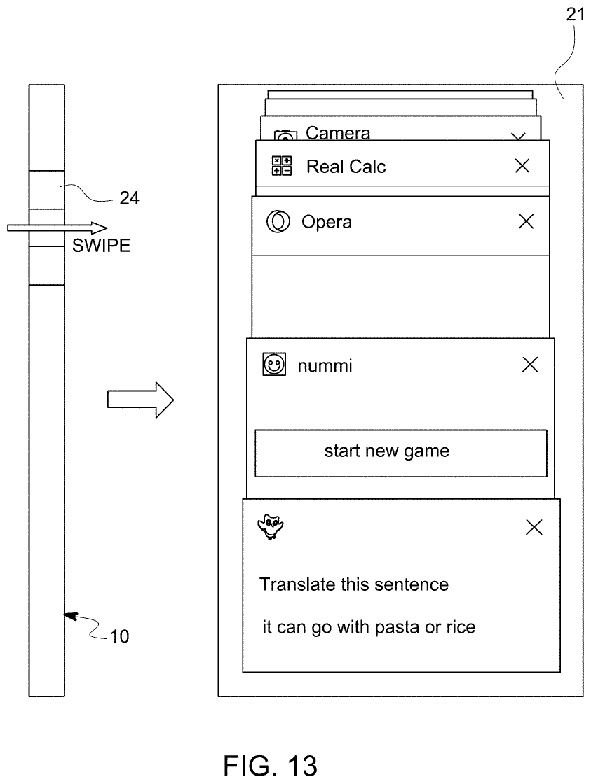

Further, as can be appreciated from FIG. 13, the system is configured such that, when the smartphone 10 is unlocked, swiping on the thumbpiece 24 along the lateral axis (i.e., perpendicular to the longitudinal axis) in a first direction causes the smartphone 10 to invoke the function that is the resultant of the conventional actuation of the conventional “recent apps” key 20 (FIG. 1) thereby displaying recent apps in a cascading fashion, or the like, depending on the User Interface (UI) design of the smartphone 10 operating system. Notably, as the recent apps are displayed, swiping on the thumbpiece 24 along the longitudinal axis causes the recent apps to be scrolled accordingly. The first direction may comprise the direction that is away from oneself as the smartphone 10 is standard-gripped. In one embodiment, the system is configured to preselect one “recent app” at any given time as the recent apps are scrolled. At this point, the system is configured such that, single-tapping 32 on the thumbpiece 24 re-launches the preselected recent app from the background.

In an additional embodiment, long-tapping 38 on the preselected “recent app” may open up additional options pertaining to said recent app preferably in a pop-up menu style. At this point, the user is, by further performing longitudinal (vertical) swiping on the thumbpiece 24, enabled to preselect said additional options one option at a time. As mentioned in the earlier body of text (ref. paragraphs 63 & 64), said longitudinal swiping could either be one longitudinal swipe per option or be one single swipe to preselect all options, one at a time.

In an additional embodiment, the system is configured such that, when the user swipes laterally on the thumbpiece 24 in the first direction and holds at the extremity, the smartphone 10 is adapted to bring forth the last accessed app from the recent apps. In an alternate embodiment, the system is configured such that, when the user swipes laterally on the thumbpiece 24 in the first direction twice, the smartphone 10 is adapted to bring forth the last accessed app from the recent apps. Performing so again results in the recent app being brought forth from the background wherein, said recent app is previous to the last accessed app.

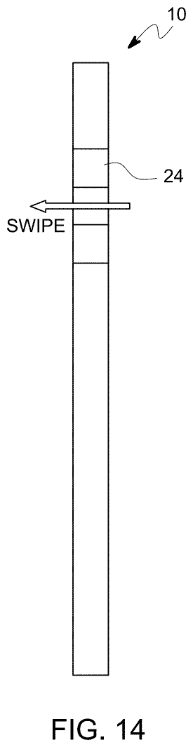

Further, as can be appreciated from FIG. 14, the system is configured such that, when the smartphone 10 is displaying any screen other than the home-screen thereof, swiping on the thumbpiece 24 along the lateral axis in a second direction causes the smartphone 10 to invoke the function that is the resultant of the actuation of the conventional “back” key 18 (FIG. 1) on a conventional smartphone thereby displaying screen that is last accessed by the user. The second direction is opposite to the first and is the direction that is towards oneself when the smartphone 10 is standard-gripped. Alternatively, the first and second directions comprise the directions that are toward oneself and away from oneself respectively. In an additional embodiment, the system is configured such that, when the user swipes laterally on the thumbpiece 24 in the second direction and holds at the extremity, the smartphone 10 is adapted to land the user back on the home-screen.

In an additional embodiment, the thumbpiece 24 further comprises a fingerprint reader integrated thereinto for locking and unlocking the smartphone 10 biometrically. More particularly, the fingerprint reader may comprise an optical fingerprint reader, a capacitance fingerprint reader, an ultrasonic fingerprint reader, etc. In alternate embodiments, the system is configured such that, swiping along the lateral axis of the thumbpiece 24 may result in other functions such as, adjusting the volume, screen brightness, horizontal scrolling, locking and unlocking the smartphone 10, camera zooming and un-zooming, etc. In an alternate embodiment, the functions resulting from swiping on the thumbpiece 24 along the lateral axis are user-configurable.

In one embodiment, the thumbpiece 24 (via the touch surface) is programmed to read additional touch gestures such as, for example, double-tapping. Said double-tapping may result in the invocation of the conventional “home” key 16 (FIG. 1) on a smartphone leading to the display of the main home-screen. In another example, said double-tapping may result in the smartphone 10 being locked. In one embodiment, the thumbpiece 24 is disposed on the back surface of the smartphone 10 so as to be accessible by the index finger. In an alternate embodiment, the function(s) resulting from the double-tap are user-configurable. Notably, the system is configured such that, the touch-gestures on the display 21 of the smartphone 10 always override the touch-gestures on the thumbpiece 24 whereby, any accidental gesturing on the thumbpiece 24 will not interrupt the user's interaction with the smartphone 10 touchscreen. Alternatively, operating the thumbpiece 24 in the aforementioned ways may result in the activation of a different functions that may be preconfigured or user-configured.

Referring to FIG. 1, of the three keys, aside from the volume keys 12, the middle key comprises a home key 16. In alternate embodiments, the home key 16 may be disposed before or after the pair of volume keys 12. In one embodiment, textured/embossed indicia/pattern may be added atop each physical key in order to distinguish one from the other haptically. In an alternate embodiment, the middle key could be a lock key 14.

In one embodiment, touch keys may be incorporated in lieu of clickable physical keys. In one embodiment, one or two of the keys may comprise touch keys while, the rest may comprise physical keys. In one embodiment, the thumbpiece 24 and the side edge, whereon the thumbpiece 24 is located, are configured to be monolithically integrated with pressure-sensors disposed underneath the thumbpiece 24 whereby, the side edge appears key-less. In one embodiment, the home and volume keys 12 and 16 are configured to be pressure-sensitive wherein, in one embodiment, different functions maybe assigned in response to different degrees of pressure exertion thereon. Said different functions, in an embodiment, may be user configurable.

In one embodiment, the volume keys 12 maybe disposed on the back of the smartphone 10 (so as to be accessible by the index finger), while the home key 16 is disposed on the side. Or alternatively, the home key 16 maybe disposed on the back of the smartphone 10 (so as to be accessible by the index finger), while the volume keys 12 are disposed on the side.

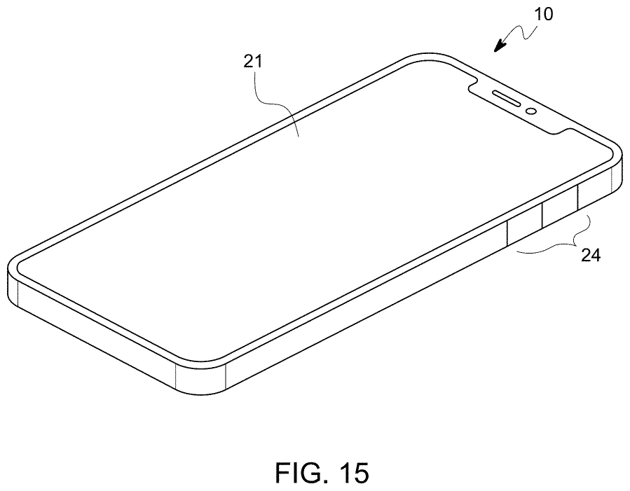

In an alternate, two-key embodiment, as seen in FIG. 15, the thumbpiece 24 may comprise only the pair of volume keys 12. In the two-key embodiment, double-tapping on the thumbpiece 24 may result in landing the user on the home-screen. Alternatively, as mentioned earlier, swiping laterally on the thumbpiece 24 towards the user (“back” function activation) and holding at the extremity may result in the user being landed on the home-screen while double-tapping may lead to the smartphone 10 being locked. In an alternate embodiment, swiping laterally on the thumbpiece 24 twice towards the user (“back” function activation) may result in the user being landed on the home-screen. In one embodiment (not shown) of the two-key embodiment, a unitary piece of volume rocker is employed in lieu of the pair of volume keys 12. In one embodiment, the volume and home keys 12 and 16 are configured to be pressure-sensitive so that, in one embodiment, different functions may be assigned in response to different degrees of pressure exertion thereon. Said different functions, in an embodiment, may be user configurable.

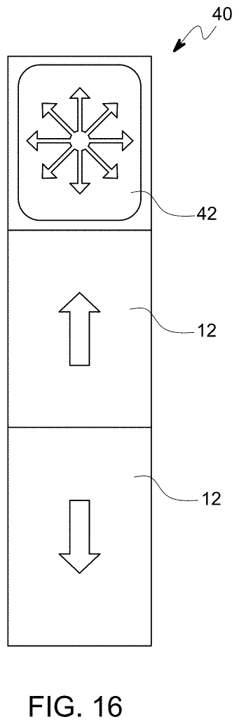

Referring to FIG. 16, in one embodiment, the thumbpiece 24 comprises a joystick 42 in lieu of one of the keys of the thumbpiece 24. The thumbpiece 24 is, in this embodiment, referred to as the joy-piece 40. The joy-piece 40 comprising a joystick 42 and a pair of touch-sensitive volume keys 12 that are located immediately before or after joystick 42. The joy-piece 40 or the joystick 42 is positioned on the side or rear of the smartphone 10 so as to be accessible by the thumb or the index finger of the user respectively. The head of the joystick 42 is preferably wider and planar (as opposed to being like a stick) for enabling the thumb of the user to ergonomically rest thereon as the joystick 42 is operated. The system is configured such that, the movement of the joystick 42 upward and downward results in the scrollable content to be scrolled accordingly. In one embodiment, the movement of the joystick 42 sideward results in the deployment of “back” and “recent apps” functions.

Referring to FIG. 16, in an additional embodiment, the joystick 42 is configured to be inwardly or downwardly actuated (i.e., pressed) resulting in a preselected item being selected. Said inward/downward actuation is akin to tapping on the thumbpiece 24. Alternatively, pressing the joystick 42 may result in the activation of a different function that may be preconfigured or user-configured. In one embodiment, the head of the joystick 42 is configured to be touch sensitive, wherein, in an embodiment, tapping (instead of pressing) thereon translates into selection of a preselected item. Alternatively, operating the joystick 42 in the aforementioned ways may result in the activation of different functions that may be preconfigured or user-configured. In another embodiment, tapping on the joystick 42 may result in the activation of a different function, which may be user configurable. In one embodiment, the head of the joystick 42 is configured to read user fingerprint(s).

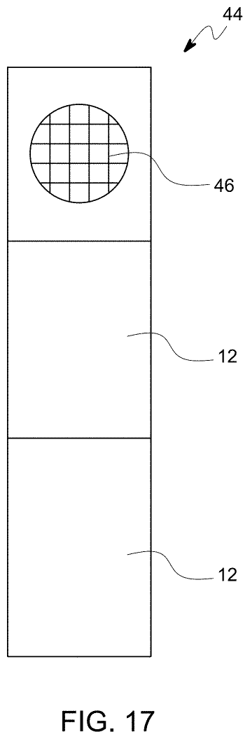

Referring to FIG. 17, in one embodiment, the thumbpiece 24 comprises a pointing-stick 46 in lieu of one of the keys of the thumbpiece 24. The thumbpiece 24 is, in this embodiment, referred to as the pointing-piece 44. The pointing-piece 44 comprises a pointing stick 46 and a pair of touch-sensitive volume keys 12 that are located immediately before or after pointing stick 46. The pointing-piece 44 or the pointing stick 46 is positioned on the side or rear of the smartphone 10 so as to be accessible by the thumb or the index finger of the user respectively. The head of the pointing stick 46 is preferably wider and planar for enabling the thumb of the user to ergonomically rest thereon as the pointing stick 46 is operated. The system is configured such that, the push of the pointing stick 46 upward and downward results in the scrollable content to be scrolled accordingly. In one embodiment, the push of the pointing stick 46 sideward results in the deployment of “back” and “recent apps” functions. In one embodiment, the head of the pointing stick 46 is configured to be touch sensitive, wherein, in an embodiment, tapping (instead of pressing) thereon translates into the selection of a preselected item. Alternatively, the touch surface overlaid atop the touch-sensitive volume keys 12 may receive the section gesture. Said tapping on the pointing stick 46 is akin to tapping on the thumbpiece 24. Alternatively, operating the pointing stick 46 in the aforementioned ways may result in the activation of a different functions that may be preconfigured or user-configured. In one embodiment, the head of the pointing stick 46 is configured to read user fingerprint(s).

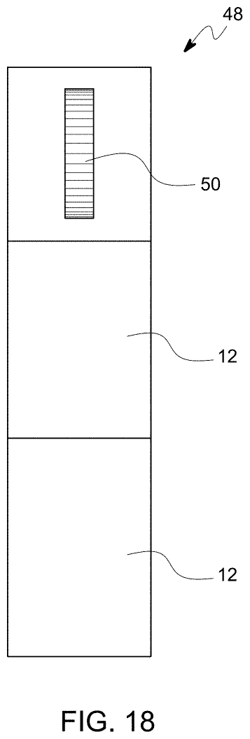

Referring to FIG. 18, in one embodiment, the thumbpiece 24 comprises a scroll wheel 50 in lieu of one of the keys of the thumbpiece 24. The thumbpiece 24 is, in this embodiment, referred to as the scroll-piece 48. The scroll-piece 48 comprises a scroll wheel 50 and a pair of touch-sensitive volume keys 12 that are located immediately before or after scroll wheel 50. The scroll-piece 48 or the scroll wheel 50 is positioned on the side or rear of the smartphone 10 so as to be accessible by the thumb or the index finger of the user respectively. The system is configured such that, the rotation of the scroll wheel 50 upward and downward results in the scrollable content to be scrolled accordingly. In one embodiment, the scroll wheel 50 is adapted to be tilted sideways wherein, as a result, the tilt of the scroll wheel 50 sideward results in the deployment of “back” and “recent apps” functions. In an additional embodiment, the scroll wheel 50 is configured to be inwardly or downwardly actuated (i.e., pressed) resulting in a preselected item to be selected. Said inward/downward actuation is akin to tapping on the thumbpiece 24. Alternatively, operating the scroll wheel 50 in the aforementioned ways may result in the activation of a different functions that may be preconfigured or user-configured. In one embodiment, the surface of the scroll wheel 50 is touch sensitive so as to receive touch-gesture inputs. In another additional embodiment, the scroll wheel 50 surface is adapted to read fingerprints for locking/unlocking the smartphone 10.

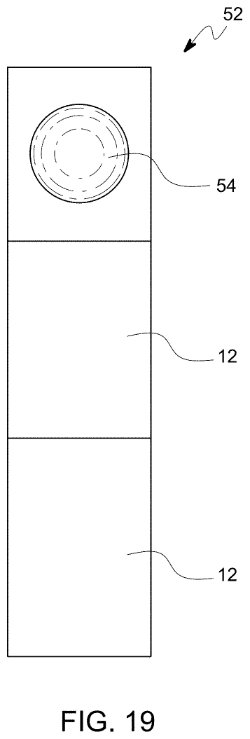

Referring to FIG. 19, in one embodiment, the thumbpiece 24 comprises a trackball 54 in lieu of one of the keys of the thumbpiece 24. The thumbpiece 24 is, in this embodiment, referred to as the track-piece 52. The track-piece 52 comprises a trackball 54 and a pair of touch-sensitive volume keys 12 that are located immediately before or after trackball 54. The track-piece 52 or the trackball 54 is positioned on the side or rear of the smartphone 10 so as to be accessible by the thumb or the index finger of the user respectively. The system is configured such that, the rotation of the trackball 54 upward and downward results in the scrollable content to be scrolled accordingly. The rotation of the trackball 54 sideways results in the deployment of “back” and “recent apps” functions. In an additional embodiment, the trackball 54 is configured to be inwardly or downwardly actuated (i.e., pressed) resulting in a preselected item to be selected. Said inward/downward actuation is akin to tapping on the thumbpiece 24. Alternatively, operating the trackball 54 in the aforementioned ways may result in the activation of a different functions that may be preconfigured or user-configured. In one embodiment, the surface of the trackball 54 is touch sensitive so as to receive touch-gesture inputs. In another additional embodiment, the trackball 54 surface is adapted to read fingerprints for locking/unlocking the smartphone 10.

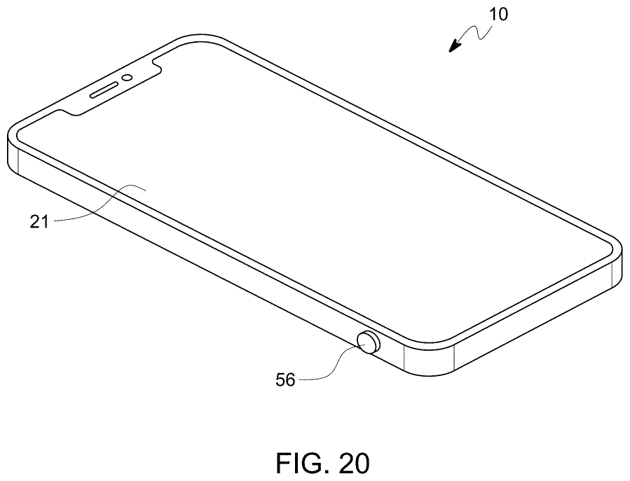

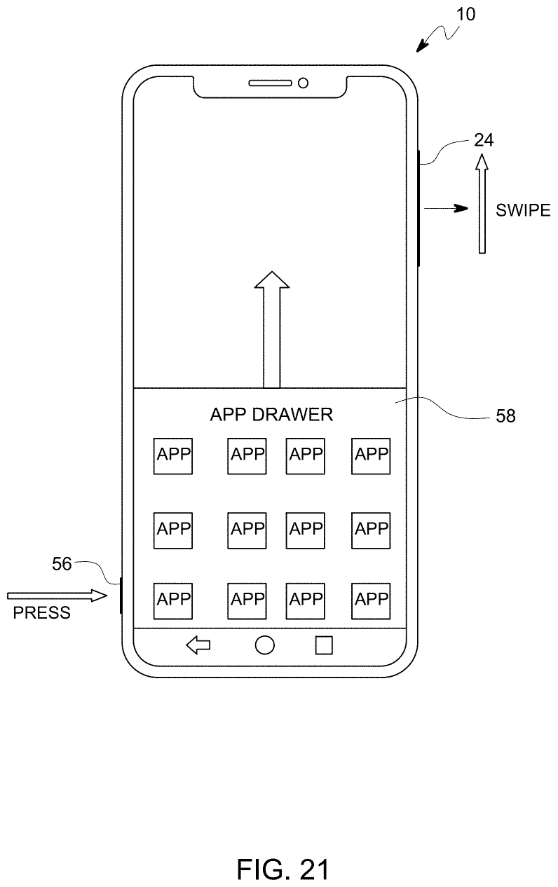

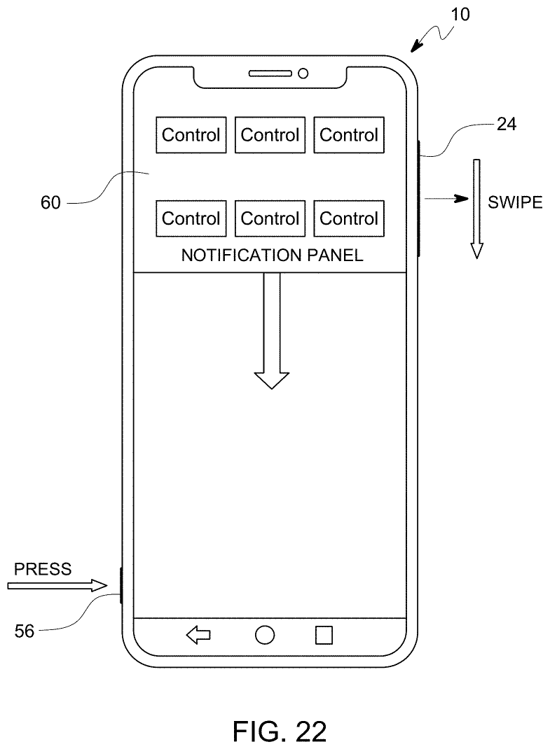

Referring to FIG. 20, the user command input assembly further includes a map key 56 disposed on the other side edge, which is opposite the side edge whereon the thumbpiece 24 is located. As there is not much wiggle room for the middle and ring fingers as the smartphone 10 is standard-gripped, the map key 56 is preferably located closer to the bottom corner of the smartphone 10 as seen in FIG. 20 so as to be accessible by the little finger. The map key 56 is configured to invoke designated smartphone functions when operated in conjunction with the thumbpiece 24. In one non-limiting example, as seen in FIG. 21, actuating the map key 56 and swiping up (along the longitudinal axis) on the thumbpiece 24 results in the app drawer 58 being launched. Notably, the app drawer 58 is configured to be launched (in the aforestated fashion) from anywhere; there's no longer the need for the user to go back to home screen to access the app drawer 58. In another non-limiting example, as seen in FIG. 22, actuating the map key 56 and swiping down on the thumbpiece 24 may result in the notification panel 60 being deployed.

In alternate embodiments, the system is configured such that, swiping along the longitudinal axis of the thumbpiece 24 in conjunction with the actuation of the map key 56 may result in the invocation of other functions such as, adjusting the volume, screen brightness, horizontal scrolling, locking and unlocking the smartphone 10, camera zooming and un-zooming, etc. In alternate embodiments, the system is configured such that, “L-gesturing” on thumbpiece 24 in conjunction with the actuation of the map key 56 may result in the invocation of other functions such as, adjusting the volume, screen brightness, horizontal scrolling, locking and unlocking the smartphone 10, camera zooming and un-zooming, etc. In an alternate embodiment, the functions resulting from swiping on the thumbpiece 24 along the longitudinal axis in conjunction with the actuation of the map key 56 are user-configurable.

Also, in alternate embodiments, the system is configured such that, swiping laterally on the thumbpiece 24 in conjunction with the actuation of the map key 56 may result in the invocation of other smartphone functions such as, adjusting the volume, screen brightness, horizontal scrolling, locking and unlocking the smartphone 10, camera zooming and un-zooming, etc. In an alternate embodiment, the functions resulting from swiping on the thumbpiece 24 along the lateral axis in conjunction with the actuation of the map key 56 are user-configurable.

In one embodiment, the system is configured to launch the app drawer 58 and the notification panel 60 by actuating the map key 56 in conjunction with the actuation of the volume up and down 12 keys respectively. In alternate embodiments, the system is configured such that, actuating the volume up and down keys 12 in conjunction with the actuation of the map key 56 may result in other functions such as, adjusting the volume, screen brightness, horizontal scrolling, locking and unlocking the smartphone 10, camera zooming and un-zooming, etc. In an alternate embodiment, the functions resulting from actuating the volume up and down keys 12 in conjunction with the actuation of the map key 56 are user-configurable.

In a non-limiting example, pressing down the map key 56 and the volume up or down 12 keys together may result in the smartphone 10 being muted. In another non-limiting example, pressing down the map key 56 and long-pressing (or pressing, holding and releasing) the volume up or down 12 keys together may result in the smartphone 10 being muted. Alternatively, simultaneously pressing down the map key 56 and pressing or long-pressing the volume up or down 12 keys together may result in the invocation of smartphone 10 functions that are user-configurable. Similarly, pressing down the map key 56 and the home key 16 together may result in the smartphone 10 being locked, switched off, a screenshot being captured, etc. Likewise, pressing down the map key 56 and long-pressing the home key 16 together may result in the smartphone 10 being locked, switched off, a screenshot being captured, etc. In alternate embodiments, pressing down the map key 56 and pressing or long-pressing the home key 16 together may result in the invocation of smartphone 10 functions that are user-configurable.

In still yet another non-limiting example, the map key 56 may itself be independently programmed to invoke a smartphone function such as, for example, double-pressing the map key 56 may launch the smartphone camera or a virtual assistant like Google Assistant®, Bixby®, Siri®, etc. In an alternate embodiment, the functions resulting from actuating the map key 56 are user-configurable. For example, long-pressing the map key 56 may result in smartphone 10 switch-off, restart prompts, etc.

In one embodiment, more than one map key 56 may be employed on the smartphone 10, wherein each map key 56 is adapted to perform differently. In one embodiment, the smartphone 10 may employ two sets of opposingly-disposed thumbpieces 24 and the map keys 56 so as to accommodate both right and left-handed usages. In one embodiment, the smartphone 10 may comprise two spaced-apart map keys 56 so as to allow a person with smaller hands to reach for the closer map key 56. Notably, in this embodiment, each map key 56 is adapted to function identically. In one embodiment, a pressure-sensor may be located underneath the map key 56 location whereby, the side edge whereon the map key 56 is rendered key-less. In one embodiment, the map key 56 is configured to be pressure-sensitive such that, different functions may be assigned in response to different degrees of pressure exertion thereon. Said different functions, in an embodiment, may be user configurable. In one embodiment, the may key 32 comprises a touch key. In one embodiment, the map key 56 may be disposed on the backside of the smartphone 10 in a way that is accessible by the index finger of the user. Notably, in the event of conflict, the gestures on the touchscreen always override the inputs received the user command input assembly.

In a virtual key embodiment, side edges of the smartphone 10 comprises touch-sensitive display screen wherein, said side touchscreens are capable of reading pressure sensitive actuation (a.k.a. 3D-touch). A virtual thumbpiece 24 and a map key 56 may be incorporated into the side touchscreens. One advantage of virtual keys over physical is that, the position of the virtual thumbpiece 24 and the map key 56 can be adjustable according to the comfortable reach of the individual user's thumb and finger(s). In one embodiment, the sides of display screen of the smartphone 10 are bent at preferably right angles at which point, the bent sections of the display screen act as the side touch screens. In one embodiment, only one side edge of the smartphone 10 may comprise a touch-sensitive screen comprising virtual key(s) while the other side may comprise physical keys.

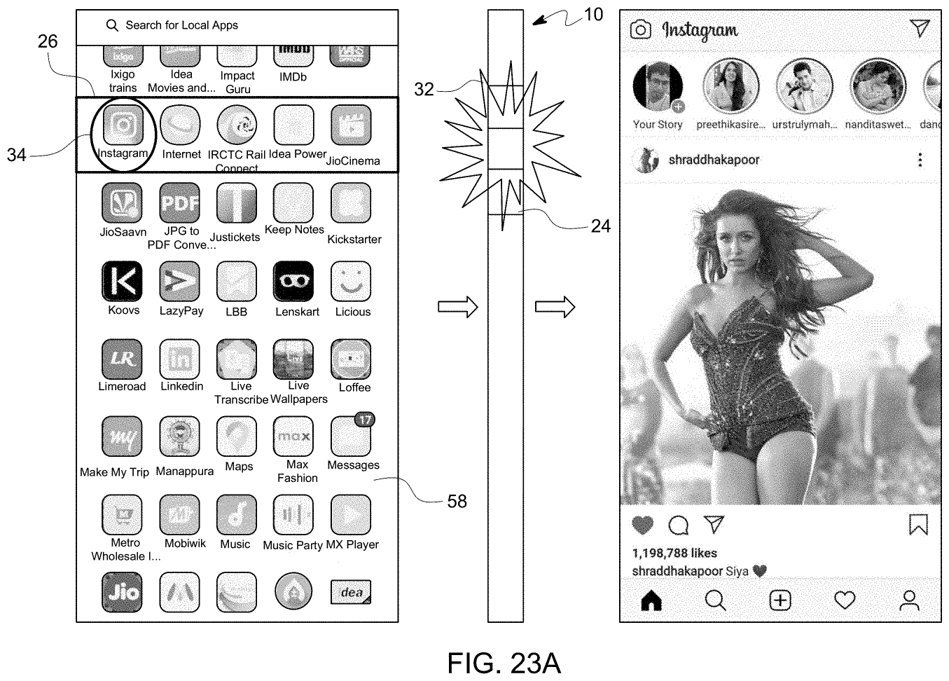

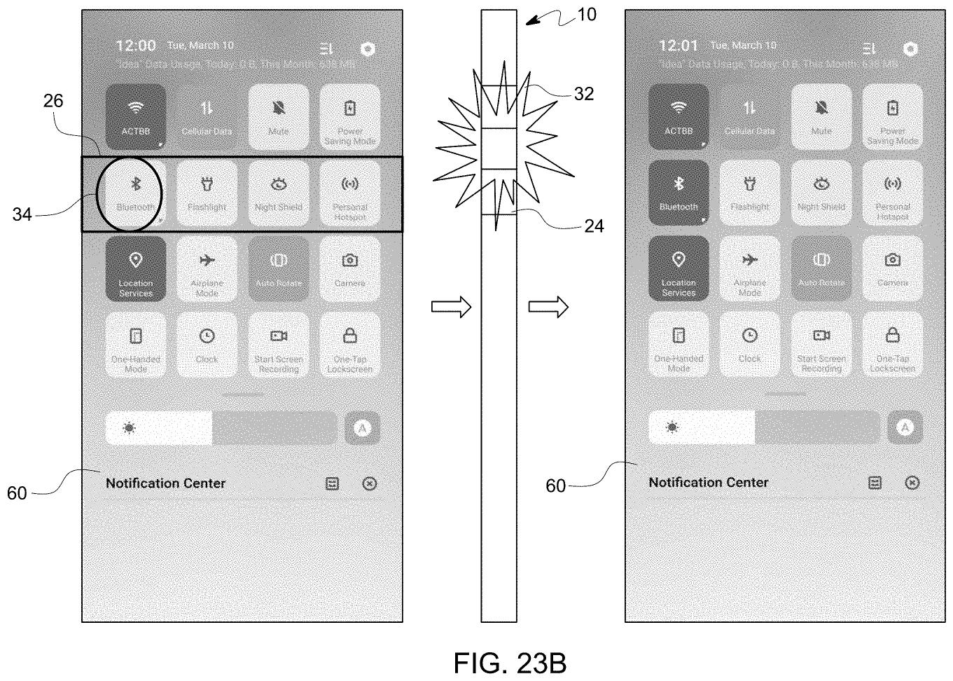

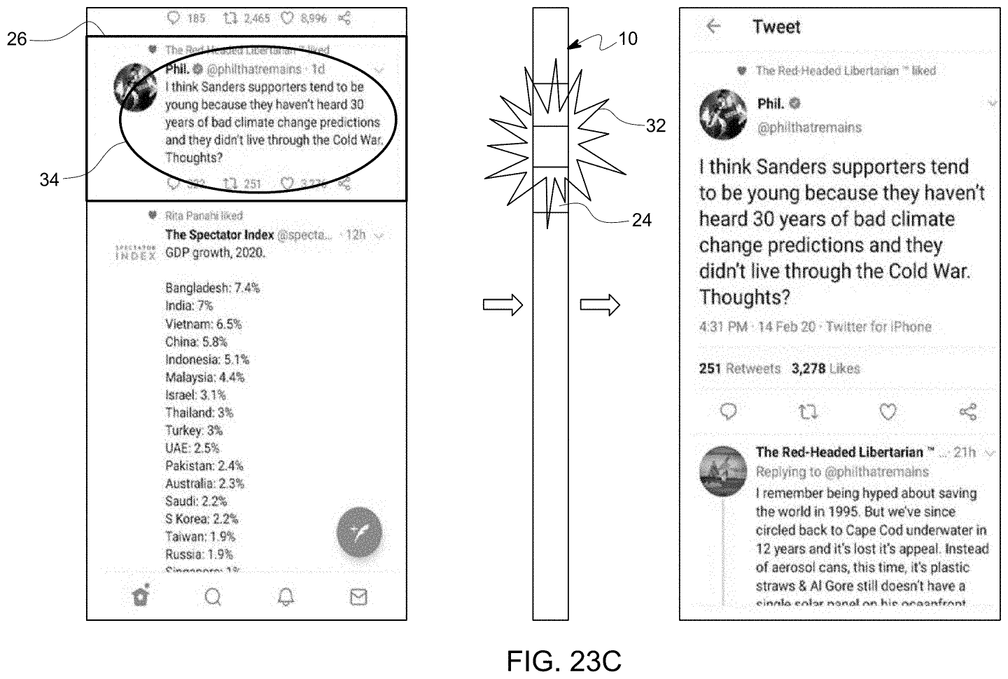

As mentioned in the preceding body of text, in the event of there being multiple focused items 62 (i.e., selectable items within the focus zone 26), the reception of a selection command 32 via the thumbpiece 24 results in the selection of the default item 64. FIGS. 23A through 23C depict the selection of a default item 64 within an app drawer 58, notification panel 60 and an app screen respectively. Notably, the default item 64 within the FIGS. 23A through 23C, which comprises an app (or app icon), a notification control, or a link respectively, comprises a preselection frame 34 disposed around it for identification purposes. In FIG. 23A, the default item 64 within the app drawer 58 is Instagram® as represented by the preselection frame 34 disposed around Instagram®. Therefore, at this point, when the selection command is inputted into the thumbpiece 24 via single-tapping 32, the Instagram app (Instagram®) is launched as seen in FIG. 23A. Notably extra-locking the default app (i.e., Instagram) results in the display of additional options (i.e., additional selectable links) pertaining to said app.

Similarly, in FIG. 23B, the default item 64 within the notification panel 60 is the Bluetooth control as represented by the preselection frame 34 around said control. Therefore, at this point, when the selection command is inputted into the thumbpiece 24, the Bluetooth is activated as seen in the illustration. Notably extra-locking the default control results in the display of additional options pertaining to the Bluetooth control wherein, said additional options may comprise the list of Bluetooth devices paired with the smartphone 10. Similarly, in FIG. 23C, the default item 64 within an exemplary Twitter app screen (Twitter®) is the tweet as represented by the preselection frame 34 around it. Therefore, at this point, when the selection command is inputted into the thumbpiece 24, the tweet is selected resulting in the opening of the landing page pertaining to the tweet as seen in the illustration. Notably extra-locking the default link (i.e., the tweet-link) may result in the display of additional options (i.e., additional selectable links) pertaining to said tweet.

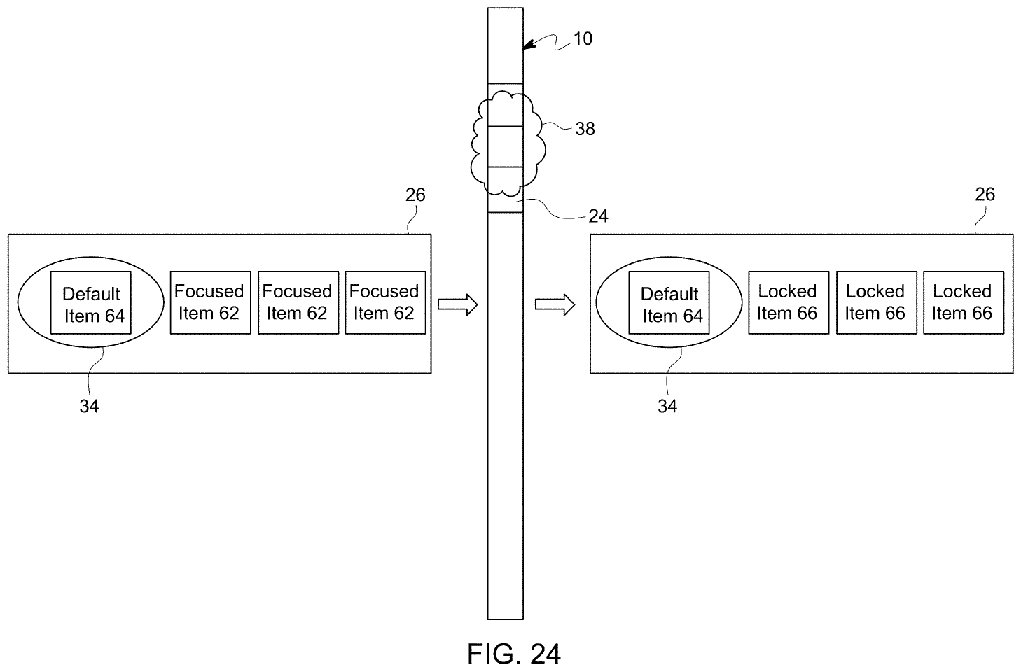

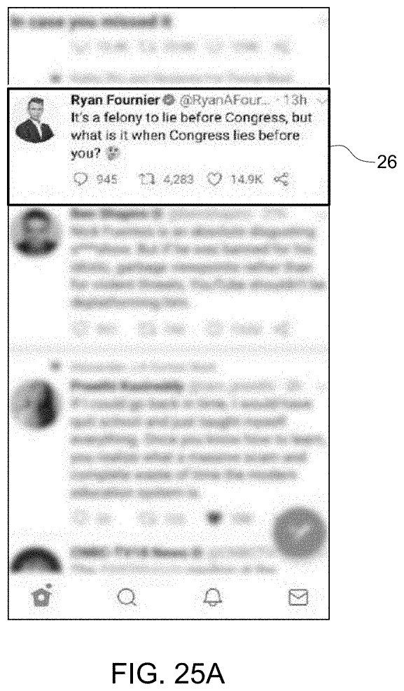

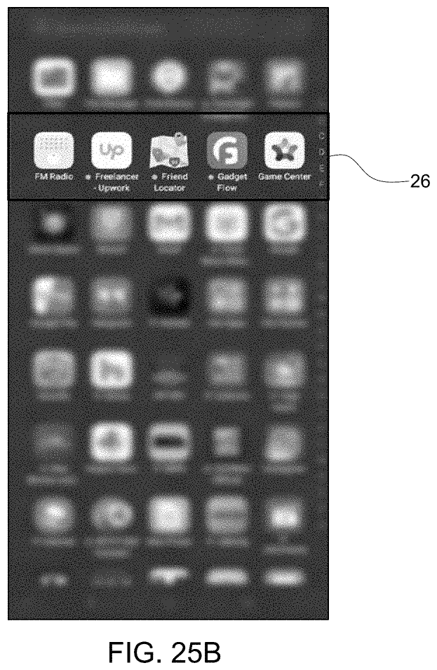

Referring to FIG. 24, in order to preselect a non-default focused item 62, the focused item 62 first need to be “locked”, which is done by inputting a lock command via the thumbpiece 24. The lock command comprises a lock gesture comprising long-tapping 38 on the thumbpiece 24. Alternatively, the lock gesture may comprise one of a myriad of touch-gesture expressions such as, double-tapping, long-tapping 38, etc. However, notably, long-tapping 38 on thumbpiece 24 for more than a predetermined threshold time doesn't result in the invocation of any smartphone function, i.e., locking in this case. In one embodiment, the system is configured such that, when focused items 62 are locked, the rest of content on the smartphone display 21 is blurred as seen in FIGS. 25A & 25B so as to cue the user into realizing that his/her area of activity is restricted to the focus zone 26. Upon “locking”, the focused item 62 are turned into and thereby referred to as “locked” items 66. Notably, only locked items 66 are eligible for preselection.

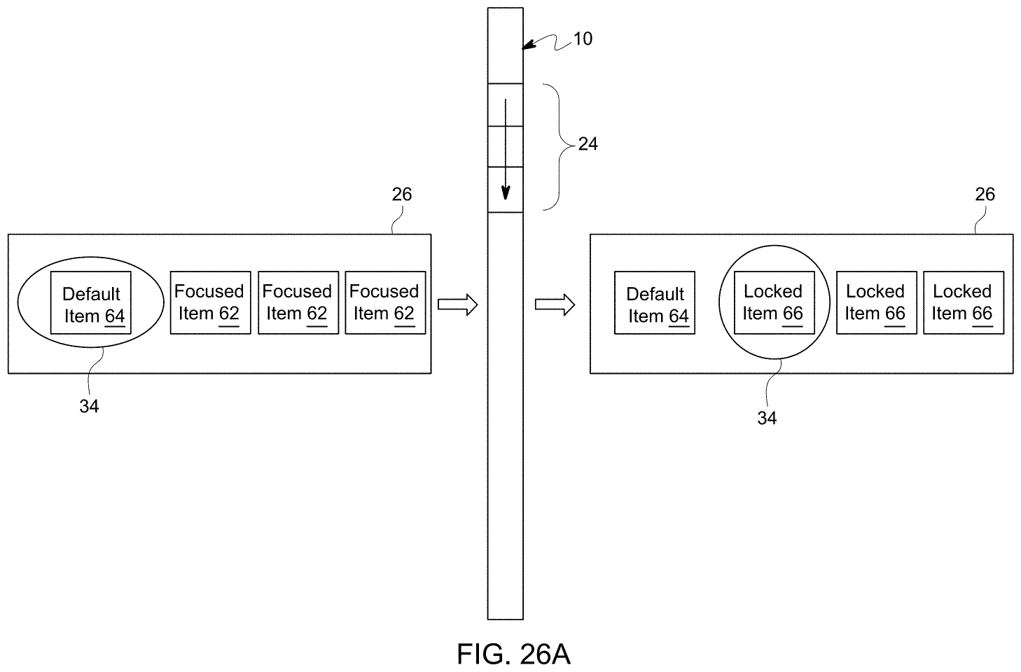

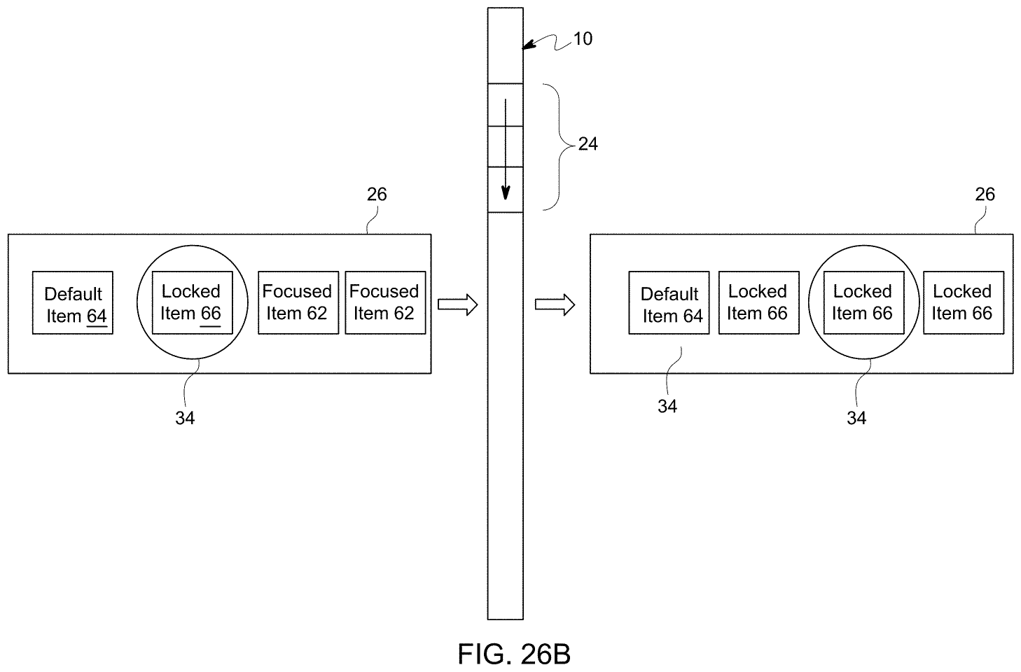

Upon “locking,” the system is configured such that, inputting a preselection command on the thumbpiece 24 results in the sequential preselection of the locked item 66. The preselection command comprises a preselection gesture comprising longitudinal swiping on the thumbpiece 24. Alternatively, the preselection gesture may comprise one of a myriad of touch-gesture expressions such as, lateral swiping, depressing the volume keys 12, extremity tapping on the thumbpiece 24, etc. Referring to FIGS. 26A and 26B, upon locking the focused item 62, swiping once on the thumbpiece 24 results in second locked item 66 next to default item 64 being preselected as represented by the preselection frame 34. Again, as seen in FIG. 26B, performing longitudinal swiping on the thumbpiece 24 results in the third locked item 66 being preselected. The last locked item 66 is preselected similarly. As mentioned in the earlier, a preselected item is selected anytime by inputting the selection command via the thumbpiece 24. Notably, the sequential preselection is limited to the selectable items within the focus zone 26.

Notably, as can be appreciated from FIG. 24, even after “locking” and before the sequential preselection is initiated by the user, one of the locked items 66 is a default item 64, which comprises the same default item 64 within the focus zone 26 before locking. Alternatively, locking is performed by depressing and holding the map key 56 whereafter, performing longitudinal swiping on the thumbpiece 24 with the map key 56 still being depressed results in the sequential preselection of the locked items 66. Notably, the longitudinal swipes are looped whereby, the last locked item 66 within the focus zone 26 could be preselected first by swiping in the reverse direction (i.e., by performing an upward swipe).

As mentioned in the earlier body of text (ref paragraphs 63 & 64), said longitudinal swiping could either be one longitudinal swipe per locked item 66 or be one single swipe to preselect all locked items 66, one at a time. Each preselected item may be extra-locked so as to display corresponding additional options (i.e., additional selectable links) preferably in a pop-up menu 36 style. In one embodiment, when no item is preselected yet, tapping on the top extremity, middle and bottom extremity of the thumbpiece 24 results in the first, middle and last locked items 66 being selected. In one embodiment, the extremity single-tapping 32 (or double-tapping) may be assigned a different function, which may be preconfigured or user-configured. Notably, the method of sequential preselection of selectable items may also be adapted to virtual keyboards wherein, the keys are laid out into a grid of rows and columns. Said keyboard could be a QWERTY keyboard, a T9 keyboard, or a number pad keyboard.

In an alternate embodiment, the focus zone 26 is eliminated and the system is configured such that, all items are locked at once and sequentially preselected by inputting the preselection command on the items results in the sequential preselection thereof. In one embodiment, said sequential preselection is limited to the items within the entire screen 21 on display, in which case, in one embodiment, the longitudinal swiping comprises carousel scrolling. Basically, in this embodiment, the entire display screen 21 serves as the focus zone 26. In another embodiment, the sequential preselection is not limited by the borders of the screen on display. In one embodiment, the sequential preselection may be restricted beyond the upper or lower threshold of the display screen 21.

In an exemplary event where the focus zone 26 encompasses a links such as a log entry pertaining to the call log screen, a contact pertaining to the contacts screen, or a setting pertaining to the settings screen, single-tapping 32 on the thumbpiece 24 results in the actuation of the default link. In an event where an exemplary settings screen has reached its end and therefore doesn't scroll anymore, the system, at this point is configured to move the focus zone 26 up and downwards to preselect the individual setting located above and below in response to the reception of a scroll command via the thumbpiece. Preferably, the scroll command comprises longitudinal swiping on the thumbpiece 24. This is applicable to other screens (call log, contacts, messages, notification panel/screen, etc.) as well.

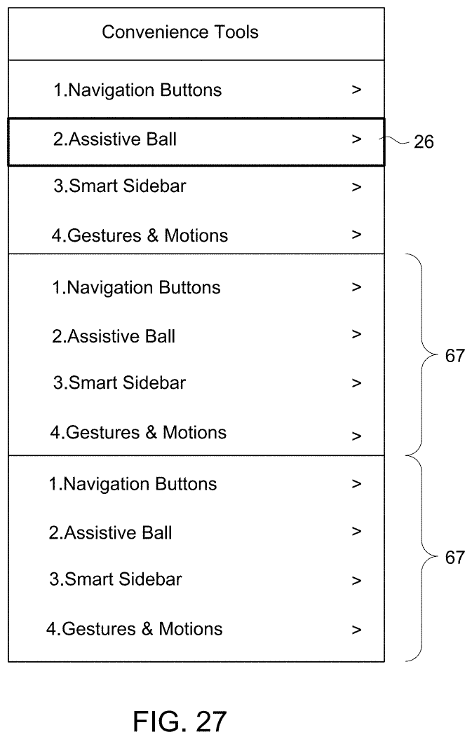

In one embodiment, the call log screen, contacts screen, messages screen, settings screen, etc., are looped (as represented by 67) thereby negating the need for the movement of the focus zone 26 in order to reach the bottom or top-most links. In an additional embodiment, as seen in FIG. 27, each link within the call log screen, contacts screen, messages screen, settings screen, etc., is numerically or alphabetically marked so as to assist the user in order not to lose track of the selectable item due to the loop 67. In alternate embodiments, color gradients or text indentation may be employed in lieu of the aforesaid marking.

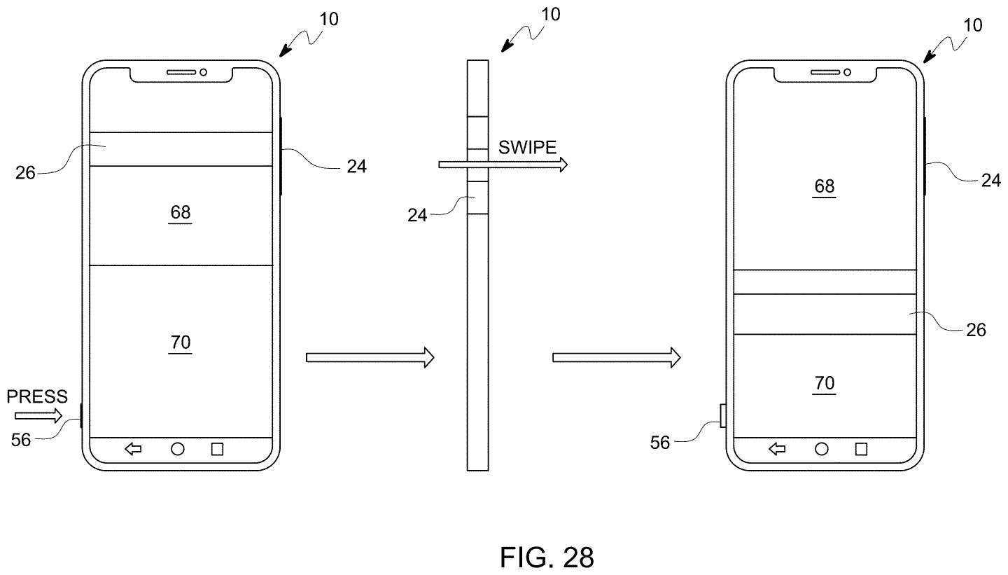

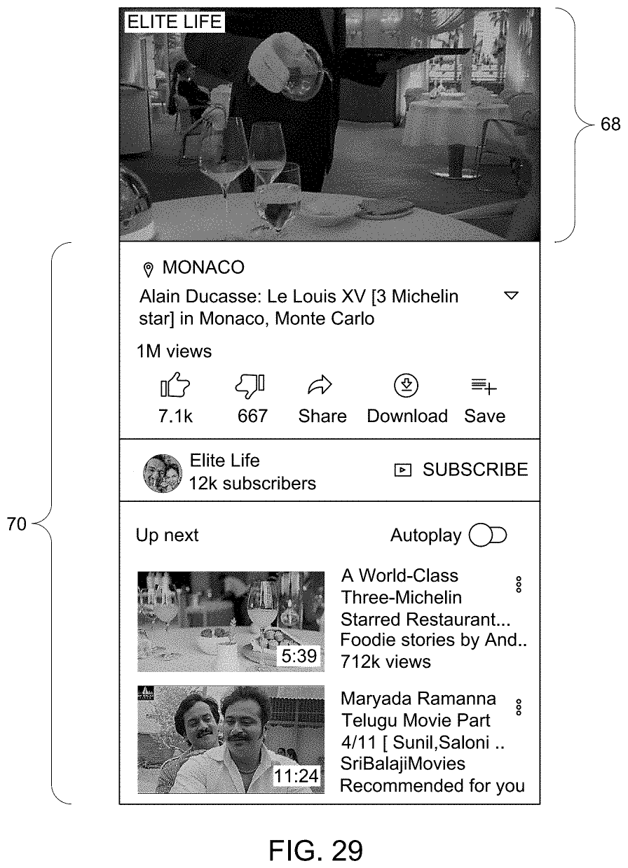

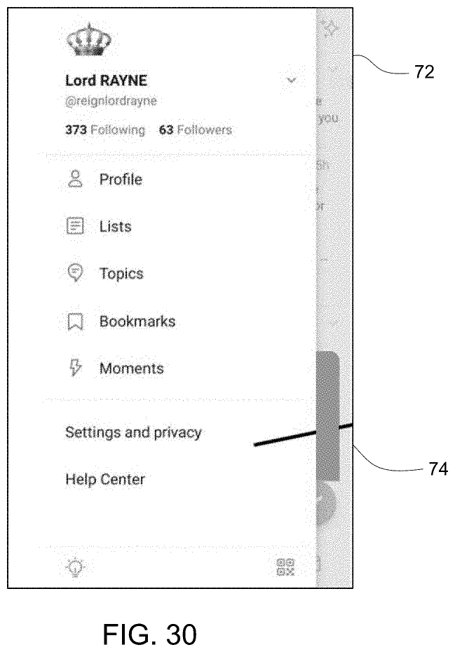

Referring to FIG. 28, in the event of multi-tasking, which comprises having two (or more than two) independent screen sections displayed on the smartphone display 21, the focus zone 26 is only a part of one of the app screens. In order to shift the focus zone 26 from the top 68 to the bottom section 70 or vice versa, all that is required is, perform the shift command, which comprises lateral swiping on the thumbpiece 24 while the map key 56 is actuated. This act of combining lateral swiping on the thumbpiece 24 and the actuation of the map key 56 is referred to as the “lateral map-swiping”. The same concept is applied to apps that have split screens. As an example, as seen in FIG. 29, one of the screens of the YouTube app (YouTube®) comprises screen split into two sections, viz., a stationary top section 68 that comprises a video playing atop, and a scrollable bottom section 70 that displays comments, etc. In order to shift the focus zone 26 from the top video section 68 to the bottom comments section 70 and vice versa, all the user needs to do is perform a lateral map-swipe on the thumbpiece 24. Similarly, generally, in some screens of some apps, certain links remain stationary while, the rest of them are scrollable. Lateral map-swiping enables a user to access links that are both stationary and mobile. The focus zone 26 is also configured to be shifted between main feed screen 72 and hamburger menu 74 of an app as seen in FIG. 30. In an alternate embodiment, a dedicated shift key (not shown) may be incorporated into the side or back of the smartphone 10, wherein actuating said shift key results in the focus zone 26 being shifted from one section to the other. In another alternate embodiment, a shift touchpad (not shown) may be integrated into the rear of the smartphone 10 wherein, performing a gesture (such as swiping, tapping, etc.) on the shift touch pad results in the focus zone 26 being shifted from one section to the other.

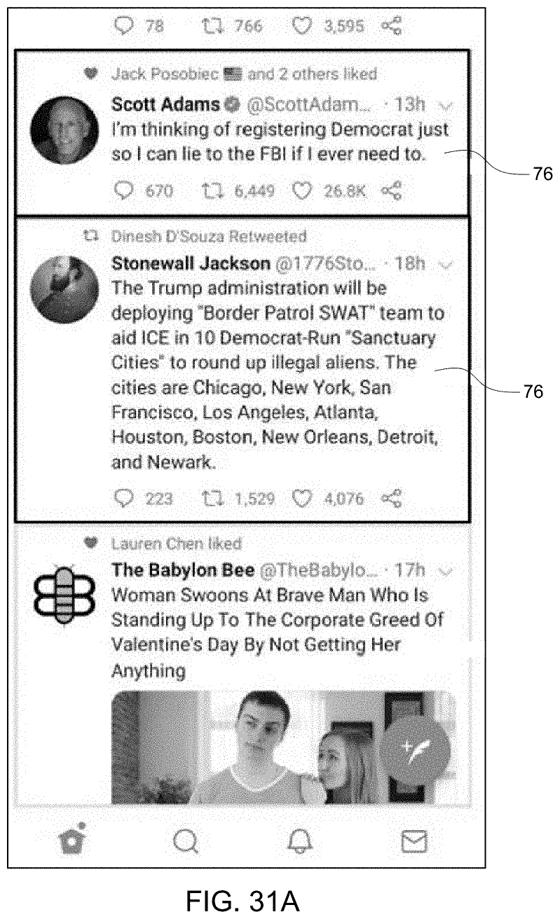

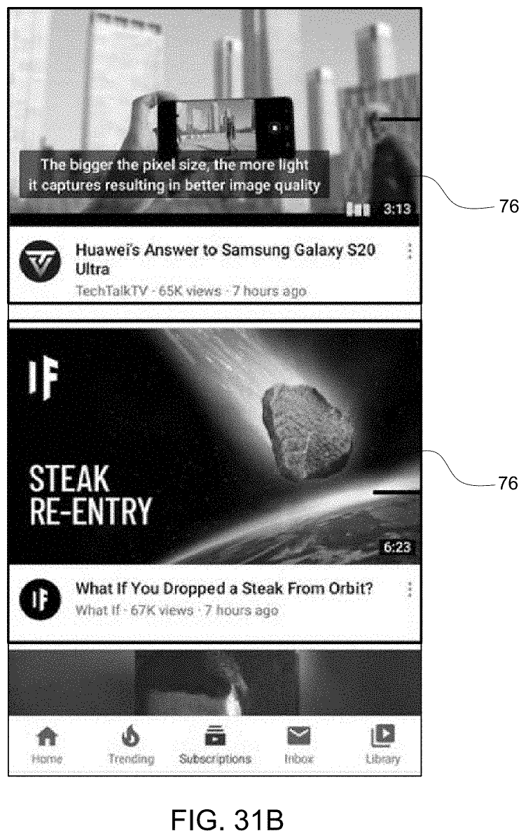

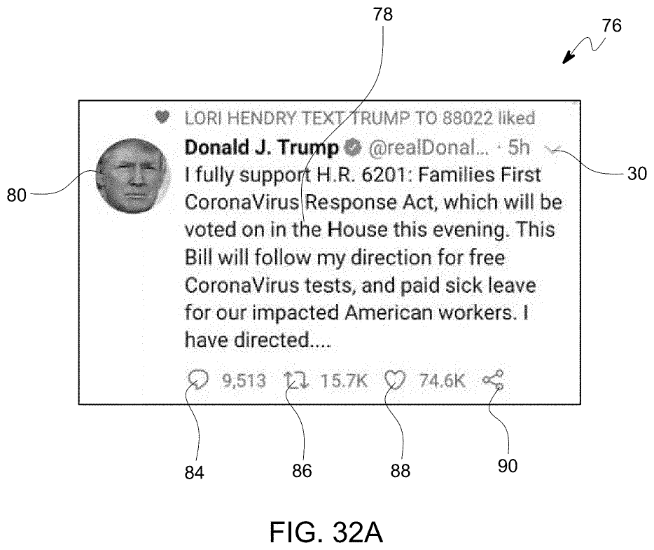

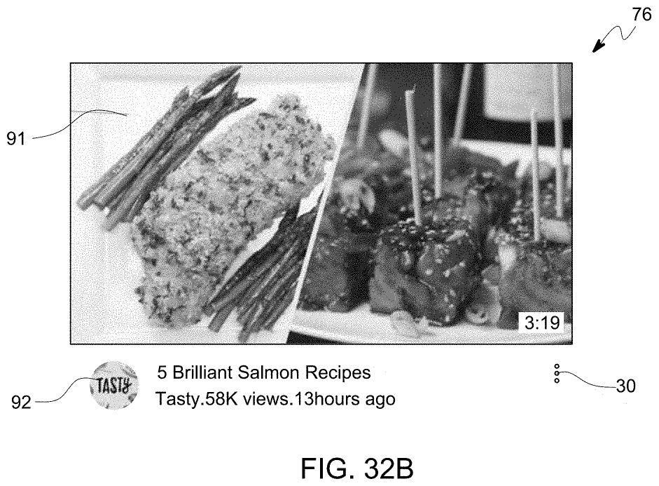

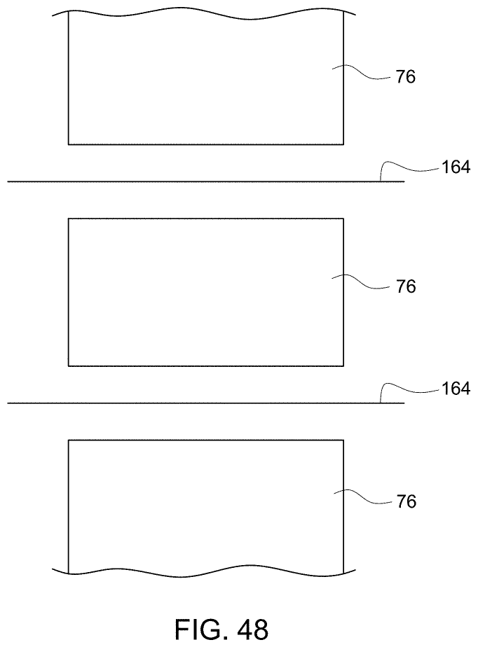

In feed-based and list-based apps (or screens) like Twitter (Twitter®), phonebook, WhatsApp®, etc., the continuous vertical feed of information therein is divided into series of clusters. For example, as seen in FIGS. 31A and 32A, each cluster 76 in Twitter generally comprises, a tweet-link 78, the link to the profile 80 of the tweet publisher, a pop-up link 30, a reply key (link) 84, a retweet key 86, a like key 88 and a share key 90. Notably, the pop-up link 30 is further divided into several other sub-links that are tucked thereinto. Referring to FIGS. 31B and 32B, in YouTube (YouTube®), the feed information is similarly divided into a series of clusters 76. Each cluster 76 comprises the video link 28, channel link 92, and a pop-up link 30, which further comprises other sub-links tucked thereinto. Therefore, basically, a cluster is collection of content that is grouped together wherein, said collection of content comprises one or more selectable items. More particularly, a cluster 76 can be a collection of related and unrelated content. The unrelated collection of content is grouped together based on proximity. A row of apps (within an app drawer 58) that are within the focus zone 26 is an example of this. Additionally, the collection of content may be grouped together based on proximity and relevance as well. One way of identifying a cluster 76 is to identify the boundary or boundaries thereof. For example, referring to FIG. 48, each cluster 76 is sandwiched between a pair of top and bottom cluster boundaries 164 (i.e., lines), which are preferably provided by the corresponding app. In an alternate embodiment, the gap between two successive clusters 76 may act as a cluster boundary 164.

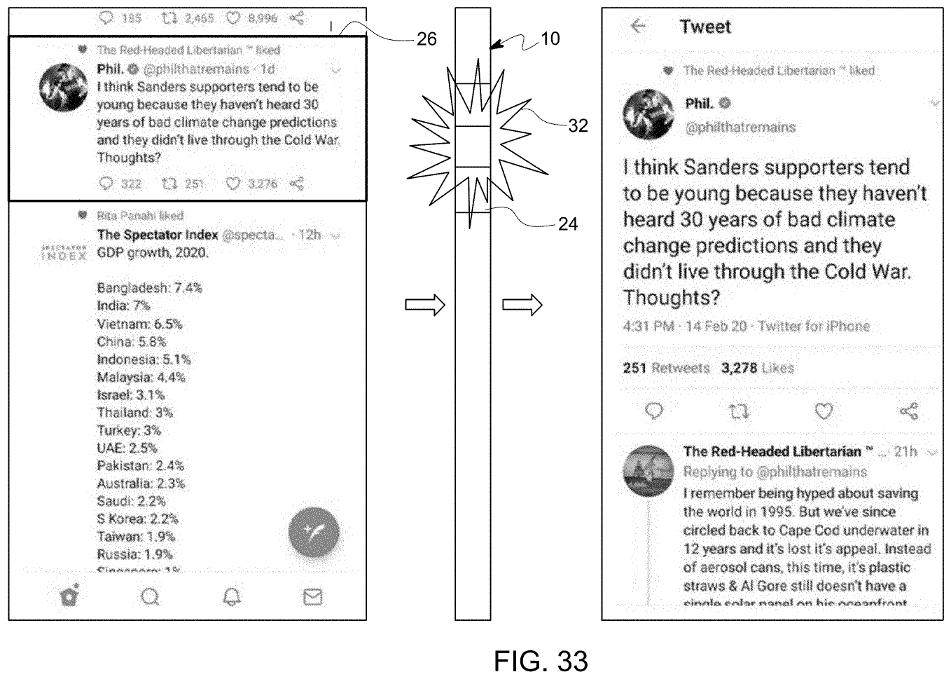

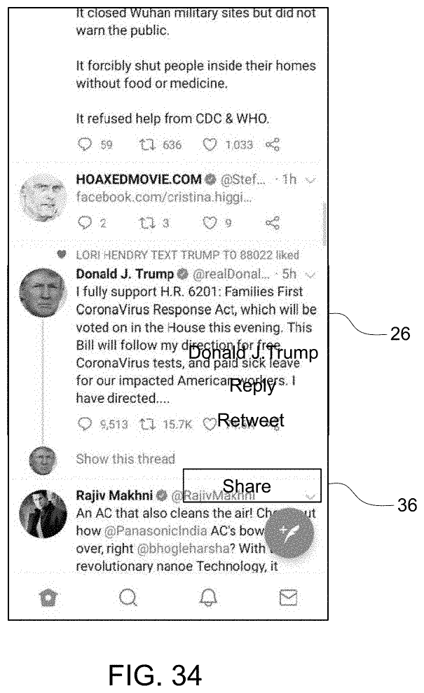

The processor is configured to identify the boundary or boundaries 164 of each cluster. Based on the boundary location information, the area of the focus zone 26 is adapted to fit or encompass (or “focus”) the entirety of a cluster within the focus zone 26. Referring to FIGS. 31A and 31B, the focus zone 26 is optimized to treat each cluster 76 as a single unit. Therefore, as content is scrolled and thereby is moved in and out of the focus zone 26, each cluster 76 is sequentially focused. This is despite the size variations between said clusters 76. For example, as can be appreciated from FIG. 31A, the width of the top cluster 76 is greater than that of the bottom cluster 76. Irrespective of the size variations, the focus zone 26, which is adaptive in nature, is optimized to treat each cluster 76 as one unit and thereby encompass (or “focus”) the entirety of each cluster 76, one at a time, as it is received within the focus zone 26. In one embodiment, the processor harnesses computer vision technology such as, OpenCV®, etc., in order to recognize clusters. In another embodiment, the processor employs Artificial Intelligence (AI) so as to recognize clusters. In yet another embodiment, backend markers from XML or any other suitable scripting/markup language (such as Python, XAML, etc.) may be employed for recognizing clusters. Alternatively, some other means may be employed for recognizing clusters. Referring to FIG. 33, the system is further configured such that, single-tapping 32 on the thumbpiece 24 when a tweet section (i.e., cluster 76) is focused results in the tweet link being selected. In other words, the tweet link is predetermined to be default link. By “locking” a focused cluster 76, the rest of the links within the locked cluster 76 are accessible for preselection. In one embodiment, upon “locking” the rest of locked links are displayed in a pop-up menu 36 style as seen in FIG. 34. In one embodiment, the system is configured such that, the pop-up-menu-style-display may not be possible when the user long-taps 38 on tweet or tweet section via the touchscreen. By swiping longitudinally on the thumbpiece 24 the, the links within the pop-up menu 36 are preselected. Notably, the sequential preselection is limited to the selectable items within the “focused cluster”, i.e., the cluster 76 within the focus zone 26.

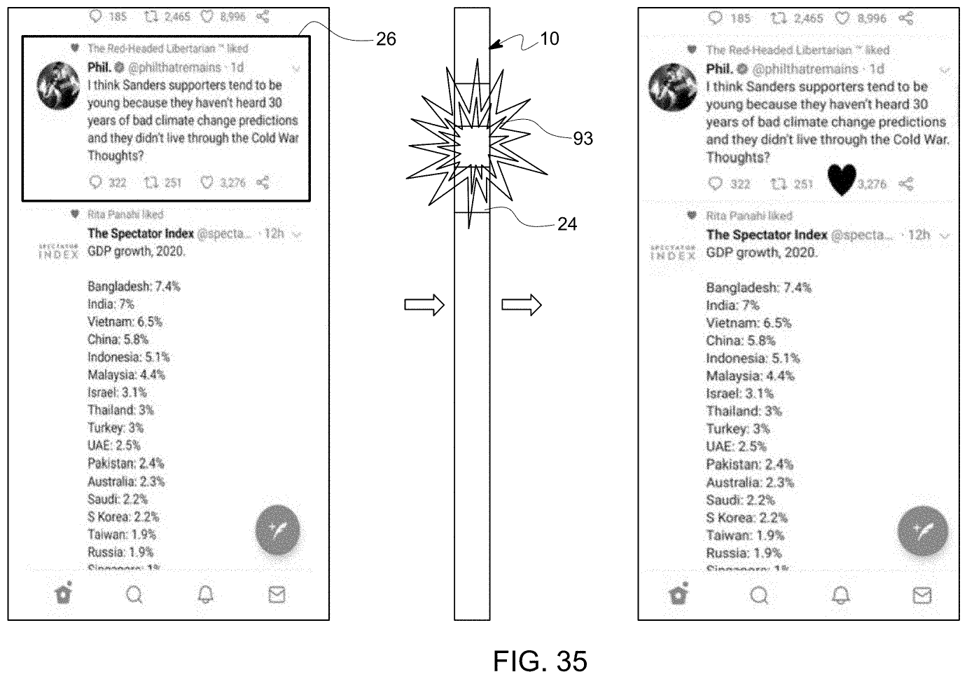

In one embodiment, the system is further optimized such that, an additional function may be assigned upon the reception of an additional selection gesture (which is an additional selection command) via the thumbpiece. Preferably, the additional selection gesture comprises double-tapping when a cluster 76 is focused. For example, as seen in FIG. 35, in Twitter (Twitter®), double-tapping 93 when a cluster 76 is focused results in the corresponding tweet being “liked”. In another example (not shown), in Instagram, double-tapping 93 when a cluster 76 is focused results in the corresponding Instagram post being “liked”. In yet another example (not shown), in YouTube®, double-tapping 93 when a cluster 76 is focused results in the corresponding video link 28 being saved for viewing later. Alternatively, the additional selection gesture (or command) may comprises other touch gestures such as, long-tapping, tapping in conjunction with the actuation of the map key, etc. The additional selection command, similar to the scroll command, selection command, preselection command, shift command, lock command, extra-lock command, etc., may be delivered by inputting at least one of the various other types of user inputs comprising a key input, a joystick input, a pointing-stick input, a scroll wheel input and a trackball input.

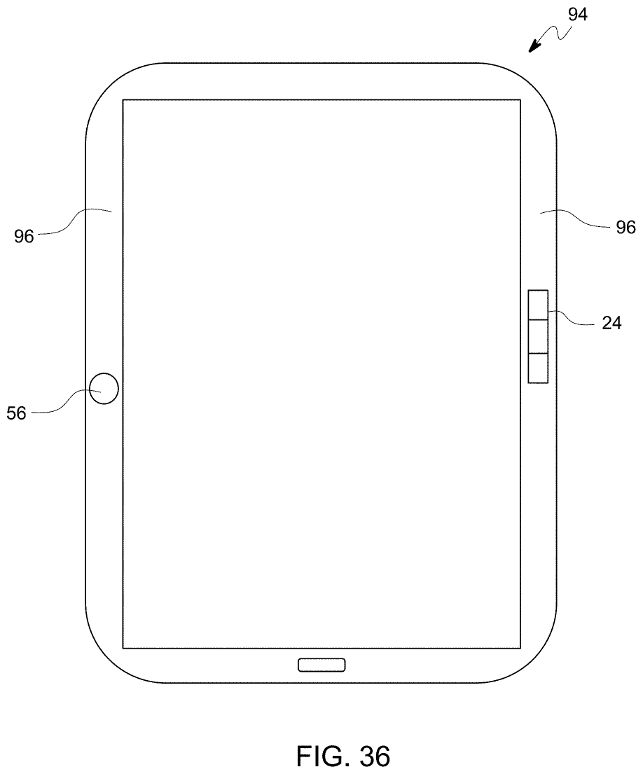

Referring to FIG. 36, the system may be extended to tablet PCs 94 as well, wherein thumbpiece 24 and the map key(s) 56 are integrated to the side bezels 96 thereof such that, touchscreen display 21, thumbpiece 24 and the map key 56 lie in the same plane. Both, the thumbpiece 24 and the map key 56 are operable by the thumb of the user so as to result in the same navigation “effect” as seen on the smartphone 10. In alternate embodiments, the thumbpiece 24, the map key(s) 56 or both of them are disposed on the back of the tab 94 so as to operable by the index fingers of the user. In one embodiment (not shown), the tab comprises virtual thumbpiece 24 and a map key 56, which are operable via the touchscreen thereof. Notably, in this embodiment, the touchscreen is pressure-sensitive. One advantage of virtual keys over physical is that, the position of the virtual thumbpiece 24 and the map key 56 can be adjustable according to the comfortable reach of the user's thumbs and fingers.

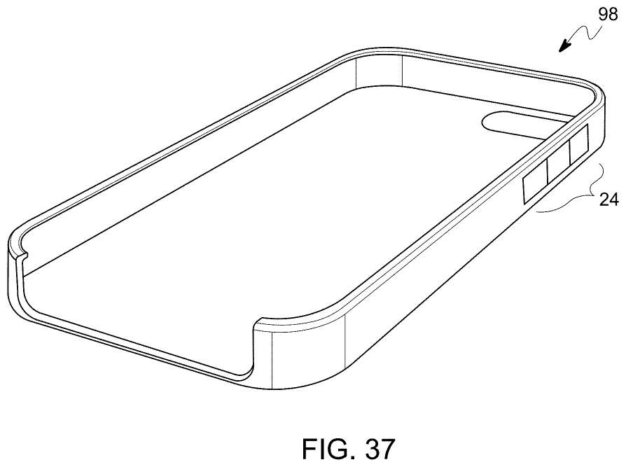

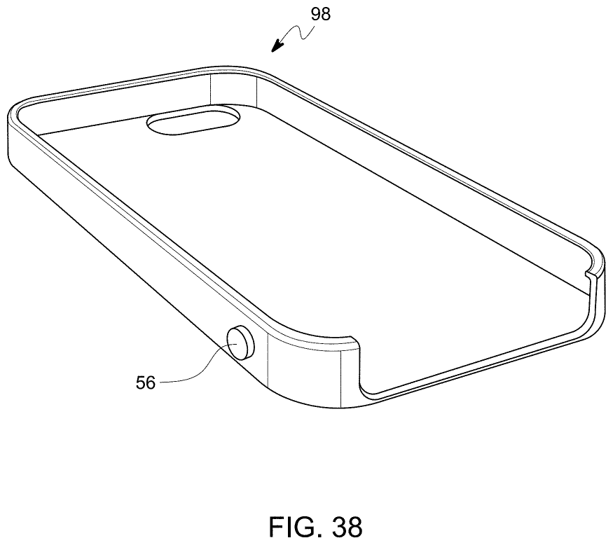

Referring to FIGS. 37 and 38, in one embodiment, the aforementioned controls on the smartphone 10, i.e., the thumbpiece 24 and map key(s) 56 are incorporated into a smartcase 98 (i.e., a smartphone case) just as the way they are incorporated into the smartphone 10. The system is configured such that, once the smartcase 98 is fitted over a corresponding prior art smartphone 10 and is paired therewith, irrespective of the native key layout of the encased smartphone, the controls are adapted to perform all of the aforesaid functions that are performed by them on the smartphone 10. More particularly, a “focus” app has to be installed on the smartphone that is encased with the smartcase 98 (or is to be encased) whereafter, the focus zone 26 is incorporated into the display 21 of the smartphone. Further, upon the installation, the smartcase 98 is enabled to communicate with the encased smartphone via said app over a wireless network such as NFC, Bluetooth, Wi-Fi, or the like.

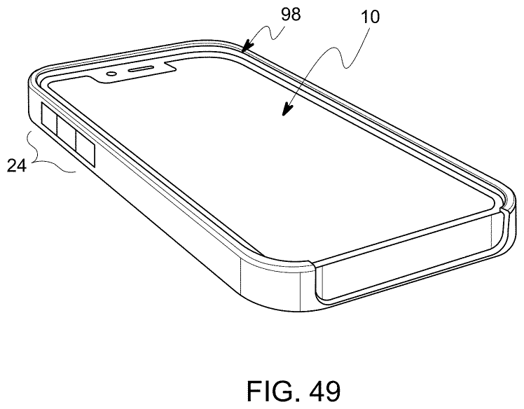

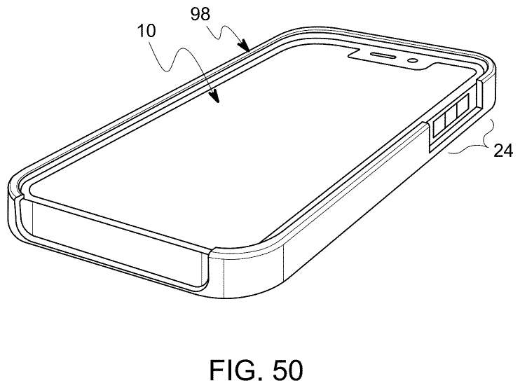

In one embodiment (not shown), the smartcase 98 may comprise a bumper case thereby removing the possibility of incorporation of the map key 56 and the thumbpiece 24 at the back. One advantage of bumper case over the smartcase 98 is that, the bumper case enables the single-handed usage of both right and left-handed usage. In one embodiment, as seen in FIG. 49, the smartcase 98 may be adapted for the smartphone 10 of the present invention wherein, said smartcase 98 comprises the thumbpiece 24 and the map key 56 on the left and rights sides of said smartcase 98 respectively so as to accommodate left-handed users. Referring to FIG. 50, in an alternate embodiment (not shown), openings may be disposed on the case for accessing the thumbpiece 24 and the map key 56 on the smartphone 10 (of the present invention) whereby, the smartphone can be used by both left & right-handedly. More particularly, the thumbpiece 24 on the case 98 is located on the left side, while the thumbpiece 24 of the smartphone 10 is located on the right. In some embodiments, the pointing-piece 44, scroll-piece 48, track-piece 52 or the joy-piece 40 may be employed in lieu of the thumbpiece 24 on the smartcase 98. The user command input assembly is integrated into the smartcase 98 comprising a smartphone 10 case that is adapted to house the smartphone 10, the user command input assembly is positioned on the smartcase 98 so as to be accessible by the user single-handedly as the smartphone with the smartcase attached thereto is standard-gripped—The smartcase 98 comprises a back panel, a pair of longitudinal side walls extending from the back panel; and an opening for snugly receiving the smartphone such that, the rear of the smartphone abuts the back panel, while the longitudinal side walls about the longitudinal side edges of the smartphone.

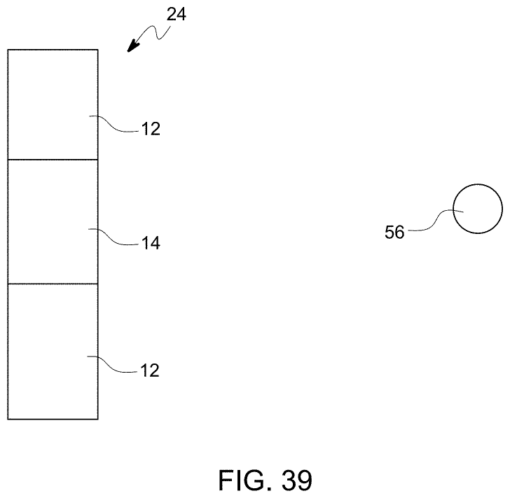

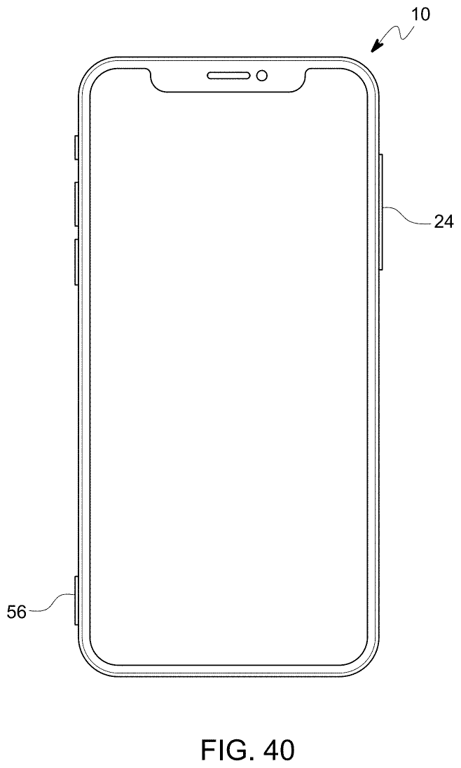

Referring to FIGS. 39 and 40, in one embodiment, the system comprises a pair of individual smart control pieces (hereinafter, “smart pieces”) viz, a thumbpiece 24 and a map key 56 wherein, each smart piece is adapted to be permanently or detachably coupled to the side edges of the smartphone 10 by means of an adhesive, Velcro®, magnet, suction, etc. More particularly, in a preferred embodiment, the thumbpiece 24 is disposed at a location where, the access thereto by the user's thumb (or index finger) is easily accomplished. Also, in a preferred embodiment, the map key 56 is disposed at a location where, the access thereto by one of the user's fingers is easily accomplished. In alternate embodiments, one of or both the smart pieces may be attached to the back of the smartphone 10 so as to be easily accessible by the user's fingers.

Referring to FIGS. 39 and 40, the system is configured such that, once the smart pieces are fitted over a corresponding smartphone 10 and are paired therewith over a wireless network, irrespective of the native key layout of the paired smartphone 10, the smart pieces are adapted to perform all of the aforesaid functions that are performed by the thumbpiece 24 and the map key(s) 56 that are integrated into the smartphone 10 as outlined in the earlier embodiments of the system. More particularly, an app may have to be installed on the paired smartphone 10 wherein, upon installation, the smart pieces are enabled to communicate with the smartphone 10 via said app over a wireless network such as NFC, Bluetooth, Wi-Fi, etc. Similarly, the smart pieces are also adapted to be attached to a tab 94 on the side bezels 96 thereof, on the back thereof, or a combination thereof. Once the smart pieces are paired with the tab 52 over a wireless network, irrespective of the native key layout of the paired tab 52, the smart pieces are adapted to perform all of the aforesaid functions that are performed by the thumbpiece 24 and the map key(s) 56 that are integrated into the tab 52 as outlined in the earlier “tab embodiment” of the computing device. As mentioned earlier, an app may have to be installed on the tab 52 wherein, upon installation, the smart pieces are enabled to communicate with the tab 52 via said app over a wireless network such as NFC, Bluetooth, Wi-Fi, etc. In some embodiments, the pointing-piece 44, scroll-piece 48, track-piece 52 or the joy-piece 40 may be employed in lieu of the thumbpiece 24.

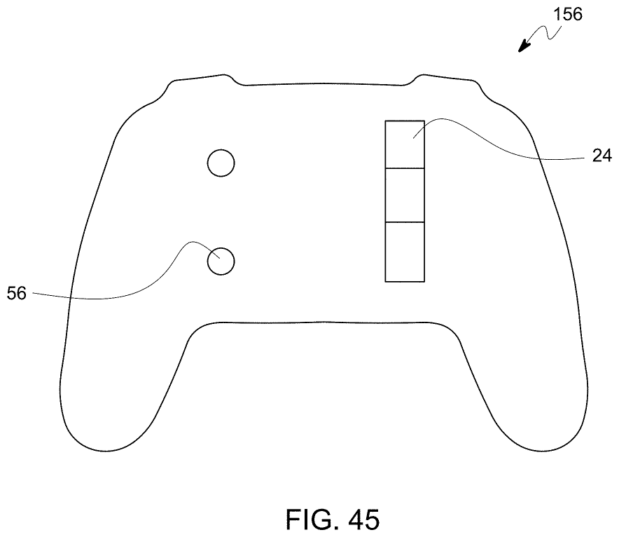

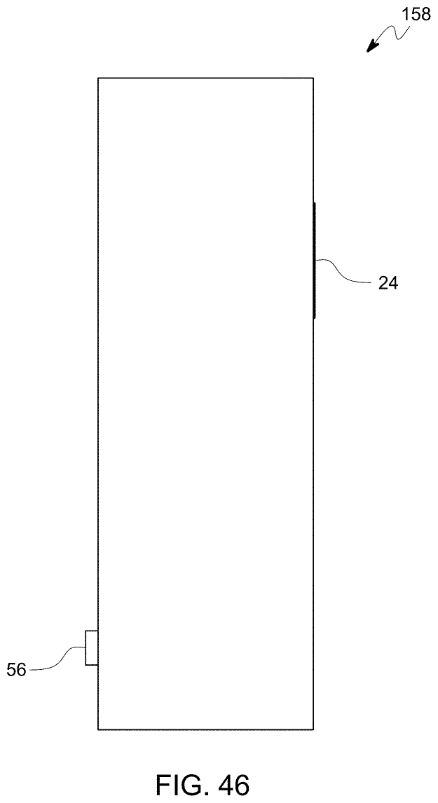

In one embodiment of the system, a larger screen device, such as, a tablet, a TV—such as the recently exhibited Samsung “Sero TV,” may be employed in place of a smartphone 10. Said larger screen device is capable of being rotated between portrait and landscape orientations. Within the display 21 of said larger device is defined the focus zone 26 wherein, the focus zone 26 becomes functional when the screen of larger device is in portrait mode. The larger device is paired with an external controller that comprises the thumbpiece 24 and the map key 56 (and probably a shift key). The external device may comprise a dedicated hardware device such as a game controller 156 (ref. FIG. 45) of a gaming console. In an exemplary embodiment, the thumbpiece 24 and the map key 56 may be incorporated into the side edges of a commonplace TV remote controller 158 as seen in FIG. 46. In another exemplary embodiment, the thumbpiece 24 and the map key 56 on the smartphone 10 may be employed in order to operate the larger screen device. Alternatively, the external device may comprise a smartphone 10 wherein, the thumbpiece 24 and the map key 56 may be incorporated as virtual elements within the display of the smartphone 10.

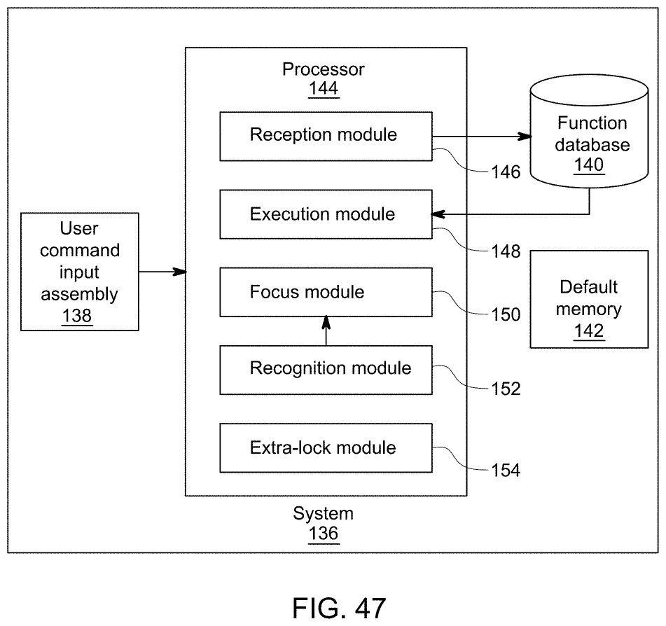

Referring to FIG. 47, the user interface system 136 comprises the user command input assembly 138, the function database 140, the display 142, and the processor 144 disposed in operative communication with one another The function database 140 comprises a plurality of user commands listed therein. Each user command is associated with function. The processor 144 is adapted to receive user commands via the user command input assembly 138. The processor 144, as enabled by the function database 140, is configured to execute the received user commands. The processor 144 is configured to identify the boundaries of a cluster. The processor 144 then optimizes the area of the focus zone to fit (or focus) the cluster. The processor 144, in conjunction with the function database 140, is configured to perform smartphone functions pertaining to user command inputs received via the user command input assembly 138.

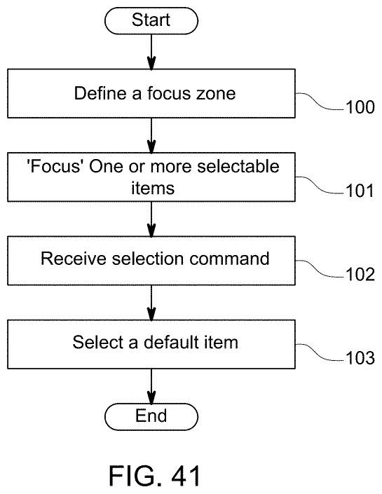

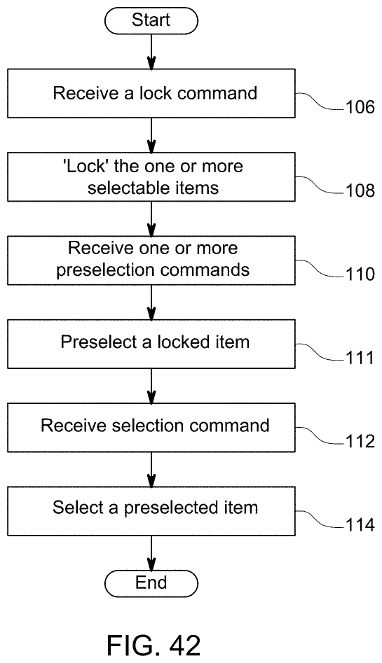

Referring to FIG. 41, in a method embodiment of the present invention, the method includes defining (step 100) a focus zone within the display of the smartphone. When one or more selectable display items are within the focus zone and thereby are “focused,” (step 101) the method further includes receiving (step 102) a selection command via the user command input assembly. The method finally includes selecting (step 104) a default item 64 of the one or more focused item 62. Referring to FIG. 42, the method of selecting a non-default item 64 of the one or more focused item 62 initiates with receiving (step 106) a lock command via the user command input assembly. Upon receiving the lock command, the method further includes locking (step 108) the one or more focused item 62 whereafter, each of the one or more locked focused item 62 is referred to as a locked item 66. Upon locking, the method further includes receiving (step 110) one or more preselection commands wherein, each of the one or more preselection commands is configured to preselect (step 111) a locked item 66. Upon an intended locked item 66 being preselected, the method further includes receiving (step 112) a selection command. The method finally includes selecting (step 114) the intended preselected item.

FIG. 43 is a block diagram of an exemplary computing device 116. The computing device 116 includes a processor 118 that executes software instructions or code stored on a non-transitory computer readable storage medium 120 to perform methods of the present disclosure. The instructions on the computer readable storage medium 120 are read and stored the instructions in storage 122 or in random access memory (RAM) 124. The storage 122 provides space for keeping static data where at least some instructions could be stored for later execution. The stored instructions may be further compiled to generate other representations of the instructions and dynamically stored in the RAM 124. The processor 118 reads instructions from the RAM 124 and performs actions as instructed. The processor 118 may execute instructions stored in RAM 124 to provide several features of the present disclosure. The processor 118 may contain multiple processing units, with each processing unit potentially being designed for a specific task. Alternatively, processor 118 may contain only a single general-purpose processing unit.

The computer readable storage medium 120 any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 122. Volatile media includes dynamic memory, such as RAM 124. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge. RAM 124 may receive instructions from secondary memory using communication path. RAM 124 is shown currently containing software instructions, such as those used in threads and stacks, constituting shared environment and/or user programs. Shared environment includes operating systems, device drivers, virtual machines, etc., which provide a (common) run time environment for execution of user programs. The computing device 116 further includes an output device 126 to provide at least some of the results of the execution as output including, but not limited to, visual information to users. The output device 126 can include a display on computing devices. For example, the display can be a mobile phone screen or a laptop screen. GUIs and/or text are presented as an output on the display screen. The computing device 116 further includes input device 128 to provide a user or another device with mechanisms for entering data and/or otherwise interact with the computing device 116. The input device may include, for example, a keyboard, a keypad, a mouse, or a touchscreen. The output device 126 and input device 128 are joined by one or more additional peripherals. Graphics controller generates display signals (e.g., in RGB format) to Output device 126 based on data/instructions received from CPU 710. Output device 126 contains a display screen to display the images defined by the display signals. Input device 128 may correspond to a keyboard and a pointing device (e.g., touch-pad, mouse) and may be used to provide inputs. Network communicator 130 provides connectivity to a network (e.g., using Internet Protocol), and may be used to communicate with other systems connected to the network. The data source interface 132 means for receiving data from the data source means. A driver issues instructions for accessing data stored in a data source 134, the data source 134 having a data source structure, the driver containing program instructions configured for use in connection with the data source 134.

An embodiment of the present invention comprises a handheld computing device such as a smartphone 10, tablet computer 94, etc. The device (shown in FIGS. 4 to 9, 11, 13 to 24, 26, 28, 33, 35 and 36) comprises a user command input assembly located thereon for receiving user commands wherein, the user command input assembly comprises the thumbpiece 24 and the map key 56 that are mentioned in the preceding body of text, The device further comprises a processor for receiving the user commands transmitted by the user command input assembly and a focus zone 26 defined within a display thereof. When one or more user-selectable display items are within the focus zone 26, whereby the one or more selectable items are said to be focused, the reception of a selection command via the user command input assembly results in the selection of a default item of the one or more focused items. The selection of a non-default item of the one or more focused items involves receiving a lock command via the user command input assembly resulting in the one or more focused items being locked. Upon locking, receiving one or more preselection commands results in a locked item being preselected. Upon preselecting a locked item of choice, receiving the selection command results in the preselected item being selected. Notably, the lock, preselection, and the selection commands are user commands.

Embodiments and examples are described above, and those skilled in the art will be able to make various modifications to the described embodiments and examples without departing from the scope of the embodiments and examples.

Although the processes illustrated and described herein include series of steps, it will be appreciated that the different embodiments of the present disclosure are not limited by the illustrated ordering of steps. Some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

1. A user interface (UI) system, comprising:
(a) a user command input assembly for receiving user commands;
(b) a processor for receiving the user commands transmitted by the user command input assembly; and
(c) a focus zone defined within a display of a computing device, wherein when one or more selectable display items are within the focus zone, whereby the one or more selectable items are said to be focused, the reception of a selection command via the user command input assembly results in the selection of a default item of the one or more focused items; the selection command being one of the user commands.

2. The system of claim 1, wherein the processor is configured to display content in portrait orientation of the computing device.

3. The system of claim 2, wherein the focus zone is located within the top half of the display as the computing device is in portrait orientation.

4. The system of claim 2, wherein the focus zone extends between the two longitudinal edges of the display.

5. The system of claim 4, wherein the focus zone is divided into one or more segments wherein, each segment is adapted to be focused one at a time; when one or more focused items are within a focused segment, receiving a selection command results in the selection of the default item of the one or more focused items within said focused segment.

6-11. (canceled)

12. The system of claim 1, wherein the user command input assembly comprises a touch-gesture input surface.

13-18. (canceled)

19. The system of claim 12, wherein the selection command is delivered via a touch-gesture input inputted on the touch-gesture input surface.

20. (canceled)

21. The system of claim 12, wherein the touch-gesture input surface is disposed atop at least two keys; the touch-gesture input surface and the at least two keys together making up at least a part of a thumbpiece.

22. (canceled)

23. The system of claim 21, wherein the user command input assembly further comprises a map key, which is configured to be operated independently and in conjunction with the thumbpiece in order to invoke functions pertaining to the computing device.

24. The system of claim 21, wherein the at least two keys comprise three keys.

25. (canceled)

26. The system of claim 1, wherein the computing device comprises a smartphone

27. The system of claim 26, wherein the user command input assembly is located on the smartphone.

28. (canceled)

29. The system of claim 27, wherein the touch-gesture input surface is integrated into a side edge of the smartphone such that, the touch-gesture input surface is accessible by the thumb of the user as the smartphone is standard-gripped; the standard-gripping comprising gripping the smartphone in portrait orientation within the palm such that, the hand wraps around the rear of the smartphone while at least three fingers and the thumb rest on the opposing longitudinal edges of the smartphone.

30-36. (canceled)

37. The system of claim 12, wherein the computing device comprises a tablet PC.

38. The system of claim 37, wherein the touch-gesture input surface is integrated into one of the bezels of the tablet.

39. (canceled)

40. The system of claim 37, wherein the touch-gesture input surface is virtual and is located within the display of the tablet.

41. The system of claim 1, wherein the user command input assembly is located on an external input device comprising an external controller, which is disposed in operative communication with the computing device.

42-44. (canceled)

45. The system of claim 1, wherein the selection of a non-default item of the one or more focused items involves:
(a) receiving a lock command via the user command input assembly resulting in the one or more focused items being locked, the locked focused items referred to as locked items;
(b) upon locking the focused items, receiving one or more preselection commands via the user command input assembly, wherein the input of each preselection command results in a locked item being preselected; and
(c) upon preselecting a locked item, receiving the selection command resulting in the preselected item being selected; each of the lock and preselection commands being one of the user commands.

46-53. (canceled)

54. The system of claim 1, wherein as content moves in and out of the focus zone, the focus zone is adapted to focus or bring within the purview thereof one cluster at a time; a cluster comprising a collection of content that includes one or more selectable items.

55. (canceled)

56. The system of claim 1, wherein the reception of an additional selection command via the user command input assembly results in the invocation of a smartphone function pertaining to one of the one or more focused items; the additional selection command being one of the user commands.

57-58. (canceled)

59. The system of claim 1, wherein in the event of the display screen comprising multiple independent sections, the reception of a shift command via the user command input assembly results in the focus zone being shifted from one section to the other; the shift command being one of the user commands.

60-63. (canceled)

64. A handheld computing device, comprising:
(a) a user command input assembly located thereon for receiving user commands;
(b) a processor for receiving the user commands transmitted by the user command input assembly; and
(c) a focus zone defined within a display thereof, wherein when one or more selectable display items are within the focus zone, whereby the one or more selectable items are said to be focused, the reception of a selection command via the user command input assembly results in the selection of a default item of the one or more focused items, and wherein the selection of a non-default item of the one or more focused items involves receiving a lock command via the user command input assembly resulting in the one or more focused items being locked, the locked focused items referred to as locked items, upon locking the focused items, receiving one or more preselection commands via the user command input assembly, wherein the input of each preselection command results in a locked item being preselected, and upon preselecting a locked item, receiving the selection command resulting in the preselected item being selected; each of the lock preselection, and the selection commands being one of the user commands.

65. A UI method, comprising:
(a) when one or more user-selectable display items are within a focus zone defined within the display of a computing device whereby, said one or more selectable items are said to be focused, receiving a selection command via a user command input assembly; and
(b) in response to the reception of the selection command, selecting a default item of the one or more focused items; and
(c) displaying on the display, the content resulting from the selection of the default item.

66. The method of claim 65, wherein the preselection and selection of a non-default item involves:
(a) receiving a lock command via the user command input assembly;
(b) upon receiving the lock command, locking the one or more focused items;
(c) receiving one or more a preselection commands wherein, each of the one or more preselection commands preselects a locked item; and
(d) upon the preselection of a locked item, receiving the selection command; and
(e) in response to the reception of the selection command, selecting the preselected item.

67. The system of claim 54, wherein each cluster is defined by cluster boundaries.

68. The system of claim 54, wherein the sizes of clusters vary.
